(19) United States
(12) Patent Application Publication
(10) Pub. No.: US 2005/0276451 A1
(43) Pub. Date: Dec. 15, 2005

(54) Method and apparatus for sorting

(76) Inventors: Maurice J. Hunking, Dallas, OR (US); Hans G. Haimberger, Milton-Freewater, OR (US); Stephen M. Hamilton, Walla Walla, WA (US); Tracy L. McGowen, Waitsburg, WA (US)

Correspondence Address: WELLS ST. JOHN P.S., 601 W. FIRST AVENUE, SUITE 1300, SPOKANE, WA, 99201, US

(21) Appl. No.: 10/856,168

(22) Filed: May 27, 2004

(51) Int. Cl. G06K 9/00

(52) U.S. Cl. 382/110

(57) ABSTRACT

A method and apparatus for sorting is described and which includes an apparatus for forming a process stream and thereafter forcibly deforming the process stream in order to identify unacceptable portions of the process stream, and removing those unacceptable portions in a first step. Yet further the method and apparatus of the present invention further includes an inspection station which is operable to pass a beam of electromagnetic radiation through the resulting process stream which has been previously forcibly deformed to then identify unacceptable portions of the process stream which need further removal in order to provide a uniform resulting product.

### TECHNICAL FIELD

The present invention is directed to the removal of undesirable portions from a process stream such as process streams of foodstuffs. One particular embodiment of the invention is directed toward the removal of undesirable portions such as bone or bone fragments or hard cartilage from a ground meat process stream.

### BACKGROUND OF THE INVENTION

During the manufacture of many products, a process stream is often used to transport, refine, and shape the desirable portions of the process stream into final products which are then packaged and delivered to the consumer. Occasionally, undesirable portions of the process stream may be introduced into the final product along with desirable portions, thereby lowering the quality and perceived value of the final product in the eyes of the consumer. These undesirable portions may provide discomfort to the consumer and discourage them from making future purchases of the final product.

The manufacture of ground poultry meat products such as coated poultry pieces includes a specific example of a process stream that occasionally includes both desirable and undesirable portions. Here, the poultry meat is ground to a specific grind size and formed into a process stream where other ingredients may be added. This process stream may include various desirable portions that may include, but are not limited to, meat portions, fat portions, soft cartilage portions and skin portions. Occasionally, other undesirable portions may also be present in the process stream that may include bone, bone fragments, hard cartilage or foreign materials which would otherwise be undesirable to a consumer.

Various processes and equipment are known in the art that attempt to limit the amount of undesirable portions reaching the consumer. For example, in the manufacture of ground meat, mechanical de-boners are often utilized to remove undesirable portions including bones. Such de-boners often include an auger that forces the ground meat process stream through a circumferential screen having a plurality of openings that provide passage for the desirable portions while the undesirable portions which are unable to squeeze through the circular openings are urged towards a discharge by the flights of the auger. Unfortunately, significant internal pressure is developed in the process stream that causes some of the undesirable materials to deform or become oriented so they follow the path of the desirable portions. To address this problem, those skilled in the art have attempted to make screens having reduced sized openings. However, this solution has not been completely satisfactory. Reducing the size of the openings in the circumferential screen further increases the internal pressure and further requires that more force be applied to deform the product. This process also increases the possibility of damaging the desirable portions. The proliferation of these devices and integration of these elements into grinding equipment has not decreased the need for removing more undesirable portions from process stream.

Other process stream sorting equipment is available which utilizes x-ray imaging equipment in conjunction with valve diverters which are intended to re-direct undesirable portions from the process stream. Unfortunately, the use of x-ray detectors is ineffective in identifying many types of undesirable portions in a process stream because the density of the undesirable portions does not differ sufficiently from the density of the desirable portions making the final contrast insufficient to provide accurate guidance for the diverter. In addition, the process stream itself may contain desirable portions that further compound the detection challenge because some of the desirable portions may posses a density greater than the undesirable portions. Such a situation occurs when the process stream contains a significant portion of dark meat which has a higher concentration of iron.

Other methods such as optical candling, ultrasonic transmission or scattering are known in the art but none has proved sufficiently satisfactory to be commercially adopted to date.

Therefore, it has long been known that it would be desirable to have a method and apparatus for sorting which achieves the benefits which are derived from the prior art devices and practices, but further avoids the detriments individually associated therewith.

### SUMMARY OF THE INVENTION

A first aspect of the present invention relates to a sorting apparatus, which includes a product which is formed into a process stream and which includes acceptable and unacceptable portions, and which further moves along a course of travel where the product is forcibly deformed; an inspection station positioned along the course of travel and through which the process stream, which has been previously forcibly deformed, passes; an electromagnetic radiation emitter which produces a beam of electromagnetic radiation having a portion that is visibly discernible, and wherein the beam of electromagnetic radiation passes through the process stream as it moves along the course of travel and through the inspection station; an electromagnetic radiation receiver which receives at least a portion of the beam of electromagnetic radiation which has passed through the process stream, and which produces an electrical signal output; an electrical processing assembly electrically coupled to the electromagnetic radiation receiver and which processes the electrical signal output to determine the presence of unacceptable portions in the process stream; and an ejector positioned downstream of the inspection station and which is controllably coupled to the electrical processing assembly, and which removes the unacceptable portions from the process stream.

Another aspect of the present invention relates to a sorting apparatus which includes a product which is formed into a process stream and which further includes an acceptable portion having a hardness, and which passes an amount of visibly discernible electromagnetic radiation, and an unacceptable portion having a hardness which is at least about 20% greater than the hardness of the acceptable portion, and which passes an amount of visibly discernible electromagnetic radiation which is less than the amount of visibly discernible electromagnetic radiation which is passed by the acceptable portion; a capture assembly defining a channel having a distal end, and wherein a slot is formed in the capture assembly, and is positioned adjacent to the distal end of the channel, and wherein the process stream passes along the channel to the distal end thereof, and wherein the acceptable portions, and at least some of the unacceptable portions of the process stream, are forcibly deformed and pass through the slot, and at least some of the unacceptable portions cannot be forcibly deformed, and do not pass through the slot; a selectively moveable scraper borne by the capture assembly and which is operable to remove the at least some of the unacceptable portions which cannot pass through the slot from the process stream; an inspection station positioned downstream of the capture assembly and through which the process stream having the acceptable and unacceptable portions passes; an electromagnetic radiation emitter positioned in the inspection station, and which produces an electromagnetic radiation beam having a portion which is visibly discernible, and which is transmitted through the previously deformed process stream which is passing through the inspection station; an electromagnetic radiation receiver positioned in the inspection station and which receives at least a portion of the beam of electromagnetic radiation which has passed through the process stream which is passing through the inspection station, and wherein the electromagnetic radiation emitter produces an electrical signal output when unacceptable portions pass through the inspection station; an electrical processing assembly which receives the electrical signal output of the electromagnetic radiation receiver, and which determines, based upon the electrical signal output, whether an unacceptable portion has passed through the inspection station; and an ejector positioned downstream of the inspection station and which removes any remaining unacceptable portions from the process stream, and wherein the ejector is controllably coupled to the electrical processing assembly.

Yet a further aspect of the present invention relates to a sorting apparatus which includes a product which is formed into a process stream and which further includes acceptable and unacceptable portions; a first capture assembly positioned in receiving relation relative to the process stream, and which includes a main body which defines a channel having a distal end, and a first slot having a first predetermined length and width, and which is positioned near the distal end, and wherein the process stream having both acceptable and unacceptable portions passes along the channel, and acceptable portions, and at least some of the unacceptable portions of the process stream, are forcibly deformed as they pass through the first slot, and at least some of the unacceptable portions cannot be sufficiently forcibly deformed to pass through the first slot; a first selectively moveable scraper borne by the first capture assembly and which is operable to remove the at least some of the unacceptable portions which cannot pass through the first slot from the process stream; a second capture assembly positioned in downstream receiving relation relative to the first capture assembly, and which further includes a main body which defines a channel having a distal end, and a second slot having a predetermined length, and width and which is positioned near the distal end thereof, and wherein the predetermined width of the second slot is equal to or greater than the width of the first slot, and wherein the process stream having both acceptable and unacceptable portions are forcibly deformed as they pass through the second slot, and least some further unacceptable portions cannot be sufficiently forcibly deformed to pass through the second slot; a second selectively moveable scraper borne by the second capture assembly, and which is operable to remove the further unacceptable portions which cannot pass through the second slot; an inspection station positioned downstream of the second capture assembly, and which defines an inspection chamber through which the resulting process stream which includes acceptable and unacceptable portions passes; an electromagnetic radiation emitter positioned in the inspection station and which produces a beam of electromagnetic radiation which is at least partially visibly discernible, and which is transmitted at a given angle through the process stream which is traveling through the inspection station; an electromagnetic radiation receiver positioned in the inspection station, and which receives at least a portion of the beam of electromagnetic radiation which has passed through the process stream traveling through the inspection station, and wherein the electromagnetic radiation receiver produces an electrical signal output; an electrical processing assembly having a memory and which receives the electrical signal output of the electromagnetic radiation receiver, and wherein the memory stores information regarding acceptable and unacceptable products, and wherein the electrical signal output received from the electromagnetic radiation receiver is compared to the information stored in the memory to determine the presence of unacceptable portions in the process stream passing through the inspection station; and an ejector positioned downstream of the inspection station and which is operable to remove any remaining unacceptable portions of the process stream which has passed through the inspection station, and wherein the ejector is controllably coupled to the electrical processing assembly.

Still another aspect of the present invention relates to a method of sorting, and which includes providing a product having acceptable and unacceptable portions and forming the product into a moving process stream; deforming the moving process stream to identify at least some of the unacceptable portions in the moving process stream; after the step of deforming the process stream, removing the at least some of the identified unacceptable portions from the process stream; after the step of removing the at least some of the identified unacceptable portions, identifying any remaining unacceptable portions in the process stream by passing a beam of electromagnetic radiation having a visibly discernible portion through the moving process stream; and removing any remaining unacceptable portions identified by the beam of electromagnetic radiation from the moving process stream.

Another aspect of the present invention relates to a method of sorting, which includes providing a product having an acceptable portion with a first hardness and an unacceptable portion having a second hardness, and wherein the second hardness is greater than the first hardness, and forming the product into a process stream; moving the process stream along a course of travel; deforming the process stream to identify at least some of the unacceptable portions of the process stream having the second hardness; removing the at least some of the unacceptable portions of the process stream which have been identified by deforming the process stream; passing at least a portion of a beam of electromagnetic radiation through the remaining process stream, and which includes acceptable portions which pass an amount of the electromagnetic radiation, and unidentified unacceptable portions which pass an amount of the electromagnetic radiation which is less than that passed by the acceptable portions, as the remaining process stream continues to move along the course of travel; receiving the portion of the beam of electromagnetic radiation which has passed through the remaining process stream having acceptable portions and unidentified unacceptable portions; determining the presence of the previously unidentified unacceptable portions of the moving process stream based upon the received portion of the beam of electromagnetic radiation which has passed through the moving process stream; and removing the remaining unacceptable portions from the moving process stream.

Another aspect of the present invention relates to a method of sorting, and which includes forming a product into a process stream which includes acceptable and unacceptable portions; transporting the process stream through a first capture assembly which defines a first slot; passing the process stream through the first slot, and wherein the first slot has a predetermined length and width dimension, and is configured to pass acceptable portions of the process stream, and at least some of the unacceptable portions, and not pass at least some unacceptable portions of the process stream; removing the at least some of the unacceptable portions which did not pass through the first slot; transporting the process stream through a second capture assembly which defines a second slot; passing the process stream through the second slot, and wherein the second slot has a predetermined length and width dimension, and wherein the width of the second slot is greater than, or substantially equal to the width of the first slot, and wherein the process stream having both acceptable and unacceptable portions passes through the second slot, and at least some further unacceptable portions which have passed through the first slot cannot pass through the second slot; removing the at least some of the unacceptable portions which did not pass through the second slot; passing the process stream through an inspection station; transmitting a beam of electromagnetic radiation having a given wavelength and at a given angle through the process stream traveling through the inspection station; receiving a portion of the beam of electromagnetic radiation which has passed through the process stream traveling through the inspection station, and converting the received portion of the electromagnetic radiation beam into an electrical signal output; comparing the electrical signal output with other information which identifies acceptable and unacceptable portions to determine the presence of unacceptable portions in the process stream which is passing through the inspection station; and removing any remaining unacceptable portions of the process stream which have passed through the inspection station and which have been identified by the electrical signal output.

Still further another aspect of the present invention relates to a method of sorting, and which includes providing a process stream having a mixture of acceptable portions having a first hardness, and which pass a predetermined amount of visible light, and unacceptable portions having a second hardness, which is greater than the first hardness, and which further passes an amount of visible light which is less than the amount of visible light which is passed by the acceptable portions; passing the process stream through an aperture to forcibly deform the process stream and to identify and remove at least some of the unacceptable portions in the process stream which cannot deform and pass through the aperture because of their respective hardness, and wherein substantially all of the acceptable portions of the process stream, and some remaining unacceptable portions pass through the aperture, and form a resulting process stream; after the step of passing the process stream through the aperture, transmitting a beam of visibly discernible electromagnetic radiation through the resulting process stream to identify any remaining unacceptable portions in the resulting process stream; and removing the remaining unacceptable portions from the resulting process stream.

### BRIEF DESCRIPTION OF THE DRAWINGS

Preferred embodiments of the invention are described below with reference to the following accompanying drawings.

The accompanying drawings serve to explain the principals of the present invention.

FIG. 1 is a fragmentary, perspective, side elevation view of a sorting apparatus of the present invention.

FIG. 2 is a fragmentary, perspective, side elevation view of a first and second capture assembly which is utilized in connection with the present invention.

FIG. 3 is a fragmentary, side elevation view of a portion of the first and second capture assemblies as seen in FIG. 2.

FIG. 4 is a fragmentary, greatly simplified perspective view of the inspection station utilized in the present invention.

FIG. 5 is a greatly enlarged, transverse, vertical sectional view taken through line 5-5 of FIG. 4, and which illustrates features of the present invention.

FIG. 6 is a greatly simplified view of the arrangement of the inspection chamber, and an electromagnetic radiation emitter, and receiver which are employed in the present invention.

FIG. 7 is a greatly simplified, fragmentary, side elevation view of an ejector assembly utilized with the present invention,

FIG. 8 is a greatly simplified, schematic, block diagram showing the arrangement of various components and an electrical processing assembly which is useful in the present invention.

### DETAILED DESCRIPTION OF THE PREFERRED EMBODIMENTS

This disclosure of the invention is submitted in furtherance of the constitutional purposes of the U.S. Patent Laws “to promote the progress of science and useful arts” (Article 1, Section 8).

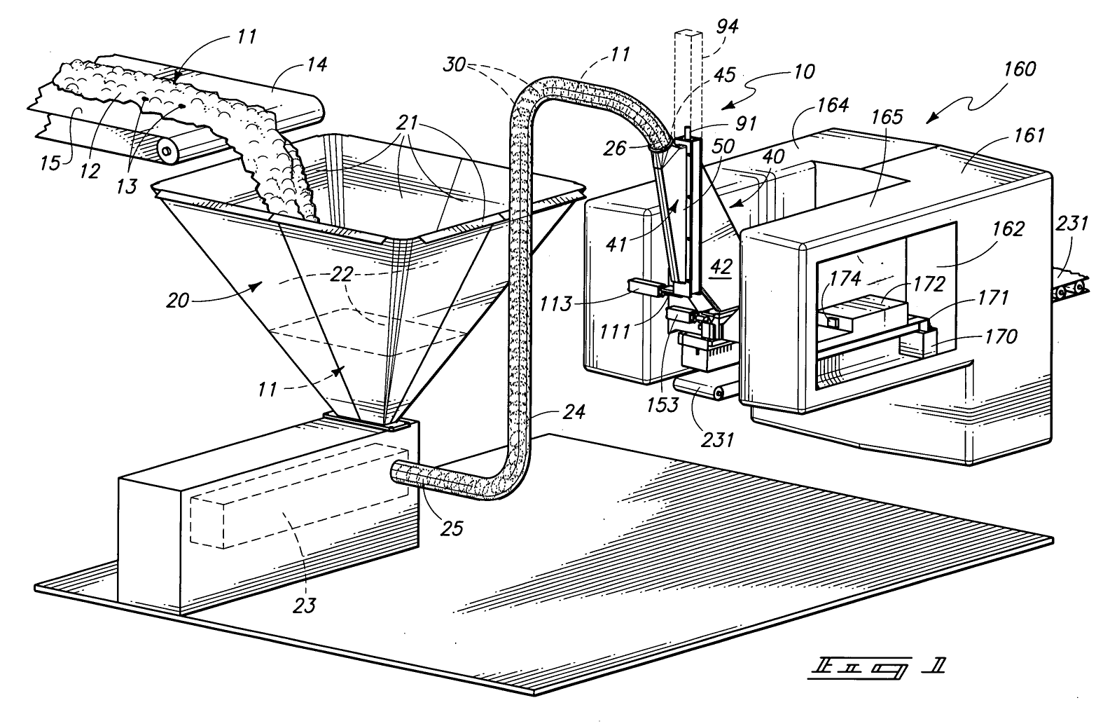

The apparatus and method of sorting of the present invention is generally indicated by the numeral 10 in FIG. 1, and following. Referring now to FIG. 1, it will be seen that the apparatus and method of the present invention includes, as a first matter, a product to be sorted and which is generally indicated by the numeral 11. The product 11 includes acceptable portions 12, and unacceptable portions 13 as will be described more fully hereinafter. In the illustration as shown, the method and apparatus 10 of the present invention is useful for sorting a product 11, such as ground meat or poultry, and separating the same from undesirable or unacceptable portions 13 which may include materials such as gristle, bone, hard cartilage, and perhaps other foreign objects which may be natural or man-made, such as plastic and the like. The product 11 to be sorted and which may include ground meat or poultry having acceptable and unacceptable portions 12 and 13 are delivered for sorting by way of an intake conveyor which is generally indicated by the numeral 14. The intake conveyor has an upwardly facing, supporting surface 15, which transfers the product to be sorted 11 along a path of travel, and deposits same in a receiving hopper which is indicated by the numeral 20. The hopper includes a sidewall 21 which defines a diminishing channel 22 which funnels or otherwise directs the product 11 to be sorted, under the influence of gravity, downwardly and into feeding relation relative to a pump which is generally indicated by the numeral 23. This pump 23 is selectively energized to move the product as a slurry, into and along a product delivery conduit which is generally indicated by the numeral 24. The product delivery conduit has a first intake end 25 which is positioned in receiving relation relative to the pump 23, and an opposite exhaust or discharge end which is generally indicated by the numeral 26. The pump 23 is operable to pump the slurry, which has now been formed into a process or product stream 30, under pressure, from the intake end 25 to the exhaust end 26 of the product delivery conduit. As will be recognized, this pressurized process stream 30 includes both the acceptable and unacceptable portions 12 and 13, respectively.

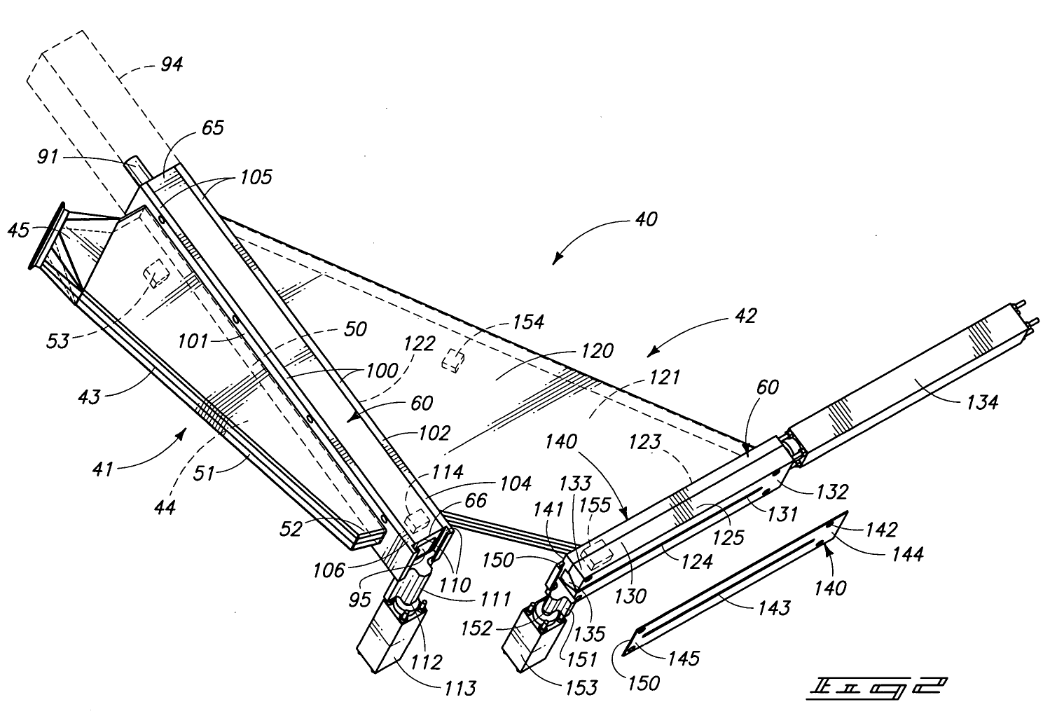

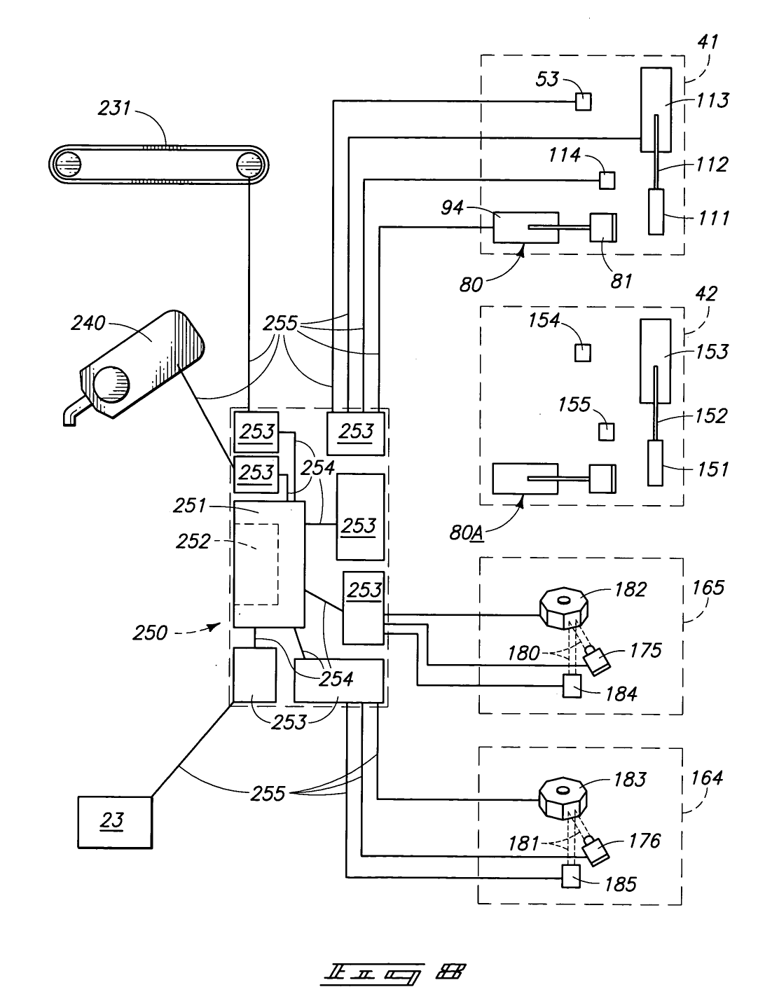

Referring now to FIGS. 1 and 2, it will be understood that the process stream 30 is delivered by the conduit 24 to a first sorting station or capture assembly which is generally indicated by the numeral 40. The capture assembly 40 includes a first capture assembly 41 and a second capture assembly 42. The first and second capture assemblies 41, 42 are coupled in fluid flowing relation one relative to the other. With respect to the first capture assembly 41 it will be seen that it is defined by a main body which is generally indicated by the numeral 43. The main body is generally narrowly triangularly shaped and defines a diminishing channel 44. The main body further has an intake end 45, which is coupled in fluid flowing relation relative to the discharge end 26 of the conduit 24. Therefore, it will be seen that the process stream 30 having acceptable 12 and unacceptable 13 portions is received, and under pressure provided by the pump 23, forced into the main body 43 of the first capture assembly 41. The diminishing channel 44 has a discharge end which is generally indicated by the numeral 50. The main body 43 is defined by sidewalls 51, as seen in FIG. 2, and which causes the product, under the influence of gravity, and pressure applied by the pump 23, to be directed towards the apex 52 of the main body 43. As will be recognized from the drawings, the main body 43, and the channel 44 formed thereby, causes the process stream 30 to be formed into a sheet having a relatively thin cross section. The triangular shaped main body urges the product 11 having defective or otherwise unacceptable portions 13 in the direction of the apex end 52. This positions the process stream 30 adjacent to another region of the capture assembly 41 which will allow for the discharge of some of the unacceptable portions 13 as will be described below. As best understood by a study of FIG. 2 and FIG. 8, the method and apparatus of the present invention includes a first pressure sensor which is generally indicated by the numeral 53, and which is located in pressure sensing relation relative to the process stream 30 which has been received internally of the main body 43. The operation of this pressure sensor will be discussed in greater detail hereinafter.

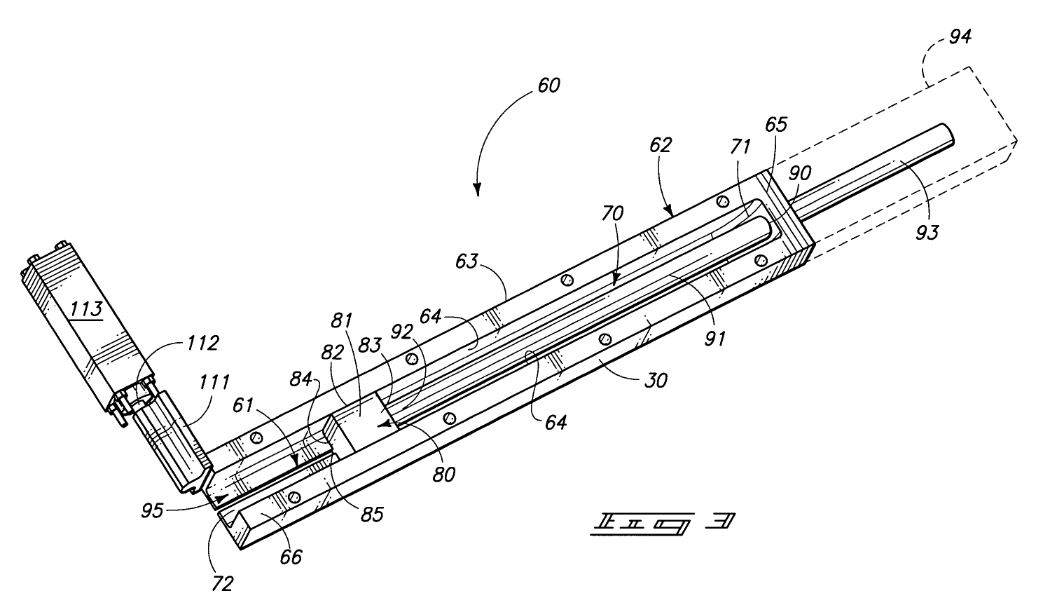

Referring now to FIGS. 2 and 3, it will be seen that the method and apparatus of the present invention 10 includes defect removal regions generally indicated by the numeral 60. These individual defect removal regions are operable to remove at least some of the unacceptable portions 13 of the product to be sorted 11 as the product 11 moves through the capture assembly 40. In this regard, each of the defect removal regions have substantially identical characteristics and therefore only one of these defect removal regions is described. It being understood that the second defect removal region is substantially identical to the first region with the exception of the size of the slot aperture which will be discussed in greater detail below. In this regard, the defect removal region positioned most closely adjacent to the discharge or exhaust end 50 of the first capture assembly 41 is defined by a first slot which is generally indicated by the numeral 61 in FIG. 3. The first slot 61 is defined by a frame 62 having an outside peripheral edge 63 and an opposite inside peripheral edge 64. The inside peripheral edge 64 defines the first slot 61. This slot has a predetermined length; and a width dimension of approximately 7/32 inch. However, this width dimension could be in a range of about ⅛ inch to about ⅜ inch. The slot width is determined based upon the product 11 being processed. Still further, the frame 62 has a first or proximal end 65 and an opposite or distal second end 66. The frame 62 defines, at least in part, a channel 70 having a first end 71, and an opposite second end 72. The channel 70 defines a course of travel for a moveable scraper which will be discussed in the paragraphs immediately below.

In the method and apparatus of the present invention 10, the first slot 61 is positioned near the distal or discharge end 50 of the first capture assembly 41. The process stream 30 passes through the first slot. As the process stream 30 passes through the first slot 61, it is forcibly deformed. In the arrangement as shown, at least some of the unacceptable portions 13 which are in the product to be sorted 11 cannot be sufficiently forcibly deformed either because of their size, or hardness, and therefore cannot pass through the slot 61. However, it should be recognized that the acceptable portions 12, and at least some of the unacceptable portions 13 do pass through the first slot 61, and then subsequently travel onto the second capture assembly 42.

Referring still to FIG. 3, it will be seen that the above described defect removal region 60 further includes a first selectively moveable scraper 80 which is borne by the capture assembly 40, and which is operable to remove the at least some of the unacceptable portions 13 which cannot pass through the first slot 61 from the process stream 30, and which is forcibly passing through the first slot 61. In this regard, the first scraper 80 has a main body 81 which is defined by an outwardly facing peripheral edge 82, and which further is dimensioned to be slideably received within the channel 70 which is defined by the frame 62. In the arrangement as shown, the first scraper 80 is reciprocally selectively moveable between the opposite first and second ends 71 and 72 of the channel, and further is moveable along the slot 61 in such a fashion so as to substantially remove any unacceptable portions 13 which cannot pass through the slot 61, because they cannot further be deformed, and remove those unacceptable portions 13 so that they do not occlude or otherwise obstruct the slot 61, or become combined or mixed with the process stream 30 at a later time. The movement of the first scraper 80 along the length of slot 61 has the effect of substantially removing the unacceptable portions 13 that cannot pass through the slot 61, and eject the unacceptable portions through a discharge port which is located adjacent to the second end 72 of the channel 70 as will be discussed below. The main body 81 of the first scraper 80 has a first sidewall 83, and a second sidewall 84. As seen in FIG. 3, the second sidewall includes a protuberance or slot clearing member 85 which is positioned or otherwise matingly received within the slot 61, and is operable to substantially remove any unacceptable portions 13 of the product 11 that may have become wedged or otherwise lodged in the slot 61, and which partially occludes same as the process stream 30 deformably passes through the slot 61. As seen in FIG. 3, an aperture 90 is formed in the frame 62 at the first end 65, thereof. The aperture 90 is operable to slideably receive a moveable ram 91, which has a first end 92, which is mounted on the main body 81 of the scraper 80, and an opposite second end 93 which is coupled in force receiving relation relative to an actuator 94 which is shown only in phantom lines, and which is mounted endwardly of the frame 62. The actuator 94 is responsive to a signal received from a controller, which will be discussed in greater detail hereinafter, to thereby periodically, and reciprocally move the scraper 80 along the length of the slot 61 to remove any unacceptable portions 13 which cannot pass through the first slot 61. The actuator 94 is of conventional design. As seen most clearly by reference to FIG. 2, a discharge port 95 is positioned adjacent to the second end 72 of the channel 70. The discharge port and the operation of same will be discussed in greater detail in the paragraph below.

Referring now to FIG. 2 and FIG. 3 the frame 62 which defines the first slot 61 is at least partially enclosed within a housing which is generally indicated by the numeral 100. The housing is defined, at least in part, by first, and second sidewalls 101 and 102, respectively. It should be appreciated from a study of FIG. 2 that the first and second sidewalls have passageways formed therein which allow for the movement of the process stream 30, therethrough, such that the process stream 30 may come into contact with the first slot 61, and be forcibly deformed, and then subsequently travel on to the second capture assembly 42. The respective sidewalls 101 and 102 each have a first end 105 and a second end 106. As seen in FIG. 2, the first and second sidewalls 101 and 102 extend outwardly from the end of the channel 62, and further have individual channels 110 formed therein. Slideably received within the individual channels 110 is a discharge gate which is generally indicated by the numeral 111. This discharge gate is selectively moveable from an occluding position relative to the discharge port 95, to a nonoccluding position relative thereto such as illustrated in FIG. 2. In the arrangement as shown, a ram 112 is mounted on the discharge gate and is further coupled in force receiving relation relative to an actuator 113. The actuator 113 is further coupled to a controller which will be discussed in greater detail hereinafter. The actuator 113 is operable to selectively position the discharge gate in the nonoccluding position when the moveable scraper 80 is traveling in a direction towards the discharge port 95, and is located in a given position relative to the first slot 61. The coordinated operation of the discharge gate 111, and the movable scraper 80, one relative to the other, will be discussed in greater detail hereinafter. As seen in FIG. 2, a blockage sensor 114 is provided and is mounted adjacent to the second end 72 of the channel 70. The blockage sensor is operable to provide an electrical signal indicating that unacceptable portions are occluding or otherwise obstructing the first slot 61. The operation of the blockage sensor will also be discussed in the paragraphs, below.

As noted earlier, the capture assembly 40 has two defect removal regions generally indicated by the numeral 60. As seen in FIGS. 2 and 3, and positioned downstream relative to the first capture assembly 41, is a second capture assembly which is generally indicated by the numeral 42. The second capture assembly has a main body 120, and which defines a channel 121 having a diminished height dimension, and which further has an intake end 122, which is coupled in fluid flowing relation relative to the first slot 61, and a discharge end 123, which communicates in fluid flowing relation relative to a second slot 124. As was described with respect to the first capture assembly 41, the second slot 124 is defined by a frame 125 which has an outside peripheral edge 130 and an opposite inside peripheral edge 131. The second slot 124 has a width dimension which is equal to, or less than, the width dimension of the first slot 61. By providing a second slot 124 having a width dimension which is substantially equal to or greater than the width dimension of the first slot 61, those unacceptable portions 13 of the process stream 30 which have passed through the first slot 61, can again have an opportunity to be captured or otherwise removed from the process stream 30 when the process stream passes along the channel 121 and thereafter is forceably deformed in order to pass through the second slot 124. Depending upon the characteristics of the process stream, in some forms of the invention, the width of the second slot may be substantially equal to or less than the width of the first slot 124. As was the case with the first slot 61, those unacceptable portions 13 which cannot, either by size, density, hardness, or other characteristics, be deformed sufficiently to pass through the second slot 124 are thereby captured by the second capture assembly 42 and can be substantially removed from the process stream 30. The frame 125 has a first end 132, and an opposite, second end 133. This frame further defines a channel, not shown. Similarly, a second scraper 80A (FIG. 8) is received in the channel defined by the frame 125, and is selectively reciprocally moveable along the channel in order to engage the unacceptable portions 13 which are captured by the second capture assembly 42, and remove them from the process stream 30. The function of the second scraper 80A is identical to that shown with respect to FIG. 3 with the exception that the second slot 124 as noted above, has a width dimension which is equal to or less than the width dimension of the first slot 61. As seen in FIG. 2, an actuator 134 is mounted on the first end. 132 of the frame 125, and is operable to move the second scraper 80A along the channel, not shown, in order to remove the unacceptable portions 13 which are captured by the second capture assembly 42. The frame 125 further defines a discharge port 135 which is positioned at the second end 133 of the frame.

The second capture assembly 42 includes a housing 140 which at least partially encloses the frame 125. The housing includes a first sidewall 141, which has a slot formed therein (not shown), and which allows for the passage of the process stream 30 between the discharge end 123 of the channel 121, and the second slot 124 that is otherwise defined by the frame 125. Still further, the housing 140 has a second sidewall 142, which is seen in FIG. 2 in a detached position relative to the frame 125, to show the structure thereunder. It will be seen that the second sidewall 142 has an aperture or slot 143 formed therein, and which allows the process stream 30, which has been deformed and passed through the second slot 124, to move through same and continue on towards an inspection station which will be described in greater detail hereinafter. Each of the respective first and second sidewalls 141 and 142 have a first end 144, and an opposite, second end 145. As was described with respect to the first capture assembly 41, the second end 145 of each of the first and second end walls 144 and 145 define individual channels generally indicated by the numeral 150. The individual channels are operable to receive a slideably moveable discharge gate 151 which is operable to selectively occlude the discharge port 135 when the movable scraper 80A is not in operation, and further is operable to move to a nonoccluding position relative to the discharge port when the scraper 80A is moved along the channel as defined by the frame 125 in order to engage and otherwise remove the unacceptable portions 13 from the process stream 30 which is being deformed and passing through the second slot 124. As seen in FIG. 2, a ram 152 is attached to the discharge gate 151 and further, an actuator 153 is mounted in force transmitting relation relative to the ram 152 in order to selectively move the discharge gate 151 into the occluding or non-occluding positions relative to the discharge port 135. Still further, and as seen in FIG. 2, the second capture assembly 42 includes a second pressure sensor 154 which is mounted in pressure sensing relation relative to the channel 121. The frame 125 also mounts a second blockage sensor 155 near the discharge port 135. The operation of the pressure and blockage sensors will be discussed in greater detail hereinafter. It will be recognized that while two capture assemblies are shown, the present invention may be rendered operable by the use of only one capture assembly or three or more capture assemblies depending upon the nature of the process stream supplied to same.

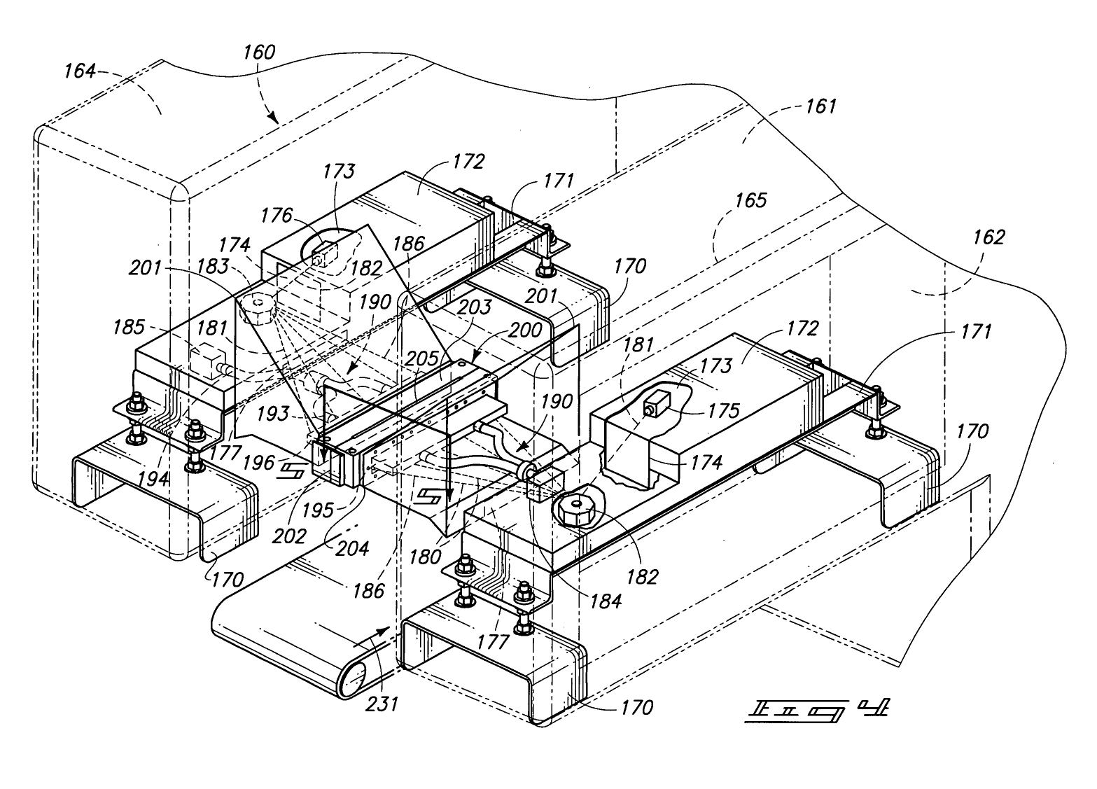

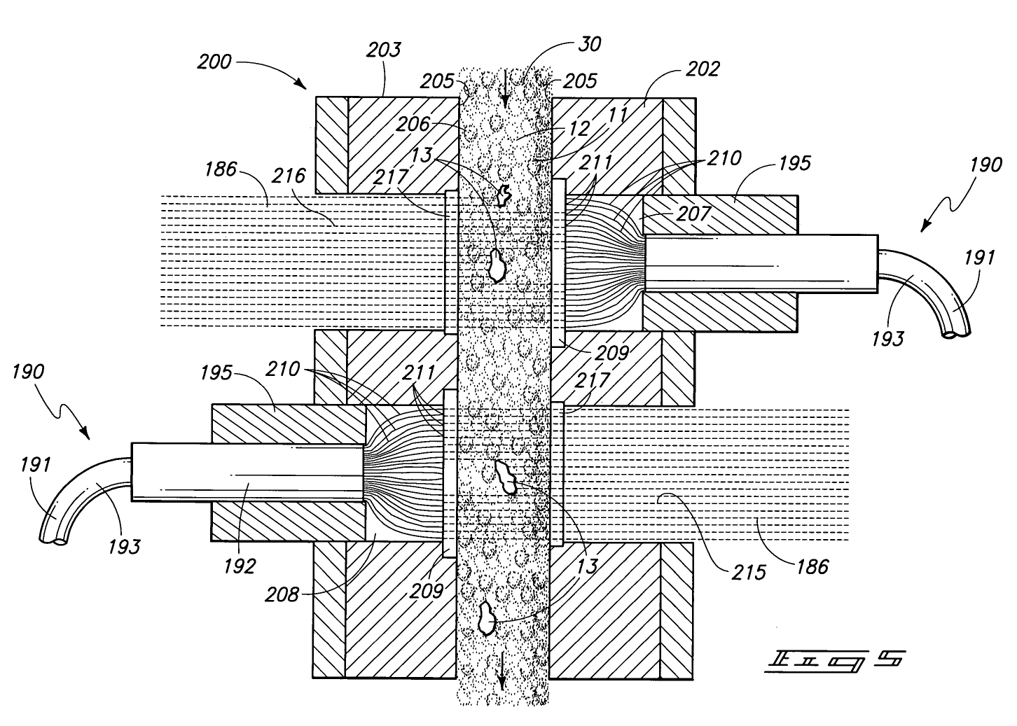

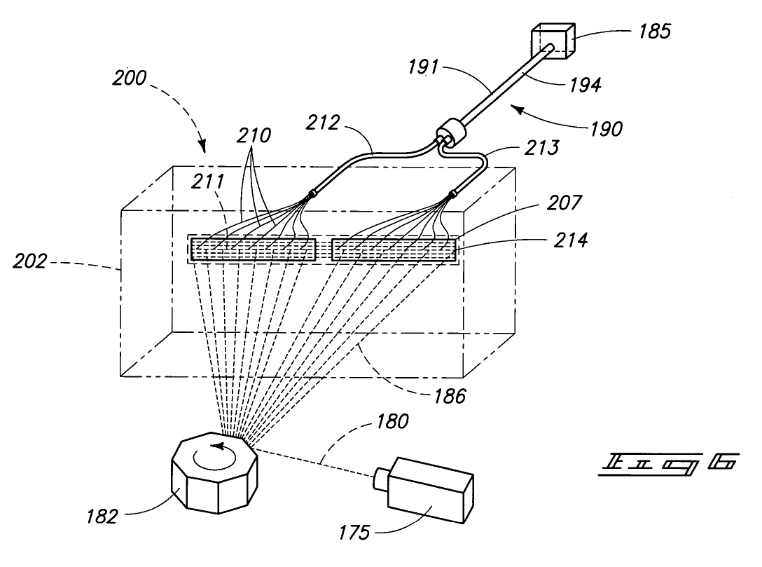

Positioned immediately downstream relative to the second capture assembly 42 is an inspection station 160. As seen in FIG. 4, the inspection station includes a housing 161 which defines an internal cavity 162. Still further, the housing defines a channel 163 which is positioned therebetween left and right equipment bays 164 and 165, respectively. The housing 161 is positioned above, and sits astride an acceptable product conveyor which will be discussed in greater detail hereinafter. The inspection station 160, which is defined in part by the housing 161, and more specifically, the left and right equipment bays 164 and 165, each mounts a plurality of spaced apart support members which are generally indicated by the numeral 170. Mounted on the respective support members 170, by suitable fasteners, are individual shelves 171. Each shelf 171 further supports an equipment housing which is generally indicated by the numeral 172. Each of the housings 172 define a cavity 173, and further has an aperture 174 formed therein and which is located in the cavity. As seen in FIG. 4, the respective housings 172 which are received in the individual left and right equipment bays 164 and 165 each mount individual first and second electromagnetic radiation emitters 175 and 176, respectively. The respective electromagnetic radiation emitters, which may comprise lasers, are individually operable to emit, once energized, electromagnetic radiation having a wavelength of about 400 to about 1000 nanometers. As will be recognized, a portion of the emitted electromagnetic radiation is visibly discernable. The electromagnetic radiation which is emitted by the respective electromagnetic radiation emitters 175 and 176 is operable to pass through the product to be sorted 11 and which passes through the inspection station 160 as will be described in greater detail below. Each of the housings 172 further define a second opening or aperture 177. As seen in FIG. 4, each of the respective electromagnetic radiation emitters 175 and 176 emit individual first and second electromagnetic radiation beams 180 and 181, and which are individually directed to, and reflected from individual first and second rotating mirrors 182 and 183, respectively. The first and second rotating mirrors cause the respective beams of electromagnetic radiation to be repeatedly scanned horizontally to produce a scanned line of light 186 (FIG. 6). This scanned line of light 186 is directed toward the inspection chamber housing as seen in FIG. 6 and which will be described below. The respective electromagnetic radiation beams have a diameter of greater than about 0.1 mm. As seen, in FIG. 4, first and second optical fibers 191 and 192 are provided. Each optical fiber includes a plurality of smaller optical fibers which are arranged in an outer sheath, and which are positioned in at least one row. The individual optical fibers 191 and 192 each have a first end 193, which is positioned in optical receiving relation relative to the reflected beam of electromagnetic radiation 181 and 182, and an opposite end 194. The respective optical fibers receive the electromagnetic radiation which has previously passed through the process stream 30, and then delivers the beam of electromagnetic radiation 181 and 182 to the individual first and second electromagnetic radiation receivers or sensors 184 and 185, respectively. The respective electromagnetic radiation receivers provide an output electrical signal which is substantially a summation of the electromagnetic radiation 180, 181 which has been received. The first and second optical fibers 191 and 192 are each mounted onto first and second receivers 195 and 196, and which matingly couple with the inspection chamber housing which will be described below. When the two beams of electromagnetic radiation 180, 181 are employed, the respective beams pass through the process stream 30 in substantially opposite directions, and are substantially parallel one relative to the other and perpendicular to the process stream 30. This is seen most clearly by a study of FIG. 5.

As best understood by a study of FIGS. 4, 5, and 6, an inspection chamber housing 200 is provided and which is located in the inspection station 160, and is further positioned in downstream receiving relation relative to the first and second capture assemblies 41 and 42, respectively. The process stream 30 which has previously been forcibly deformed, and has passed through the respective first slot 61, and the second slot 124, and which further has a width dimension of typically less than about ¼ inch, is received in the inspection chamber housing 200. The inspection chamber housing 200 is supported in the channel 163 by a pair of support structures or members 201 which extend inwardly from the left and right equipment bays 164 and 165, respectively. The inspection chamber housing 200 is positioned below, and in receiving relation relative to the process stream 30 which is exiting the first and second capture assemblies 41 and 42, respectively. The inspection chamber housing 200 has a main body 202, with a top surface 203, and a bottom surface 204. Further, the main body 202 matingly couples with the respective receivers 195 and 196. As seen in FIG. 5 of the drawings, the main body 202 has spaced, inwardly facing sidewalls 205 which extend generally vertically therebetween the top and bottom surfaces 203 and 204, and which define an internal inspection chamber 206 which has a width dimension of less than about one inch. In a preferred embodiment, this width dimension is about ¼ inch or less. As seen in FIG. 5, which shows a simplified, greatly enlarged, fragmentary, transverse, vertical sectional view taken through the main body of 202, the process stream 30 having both acceptable portions 12, and unacceptable portions 13 is positioned in the inspection chamber 206, and emitted electromagnetic radiation from the scanned light beam 186 is operable to pass therethrough.

The inspection chamber housing 200, as seen in FIG. 6, has formed therein first and second receiver stations 207 and 208, respectively, and which matingly receive the respective first and second receivers 195 and 196, respectively. A transparent window 209 is mounted endwardly of the first and second receiver stations and which permits the passage of the emitted electromagnetic radiation 186, which has previously passed through the process stream 30. As seen most clearly in FIGS. 5 and 6, and as discussed earlier, each optical fiber or cable 190 includes a plurality of smaller optical fibers, here indicated by the numeral 210. Each of these smaller optical fibers 210 have a distal end 211 and which are individually affixed to the individual transparent windows 209 in such a fashion so as to receive the emitted electromagnetic radiation 186 which has previously passed through the process stream 30. As seen in FIG. 6, the optical fiber or cable 190 is bifurcated to provide first and second portions 212 and 213, respectively. The smaller optical fibers 210 contained in each of these portions 212, and 213 are attached to the respective windows 209 in discrete rows 214 in order to achieve the greatest density possible. As many as 20-23 rows may be provided with the spacing between the rows having a dimension of approximately 0.001 inch. The main body 202 of the inspection chamber housing 200 further defines first and second electromagnetic radiation receiving apertures 215 and 216, respectively. Mounted endwardly of the respective apertures 215 and 216 are individual transparent windows 217, and which permits the scanned beam of electromagnetic radiation 186 which passes through, and along the respective apertures 215 and 216, to pass therethrough, and into contact with the process stream 30. As will be recognized by a study of the drawings, a portion of the beam of electromagnetic radiation 181, 182, and which was formed into the scanned line 186 does not reach the respective optical fibers 191, 192 in view of an unacceptable portion 13 which is present in the process stream 30, and which may constitute bone, gristle or other undesirable objects whether natural, or man-made, and which are mixed in with the acceptable portions 12. In this regard, an acceptable portion 12 of the process stream 30 has a first hardness, and which further passes a first amount of visibly discernable electromagnetic radiation 180; and an unacceptable portion 13 has a second hardness which is at least about 20% greater than the hardness of the acceptable portion, and which further passes less than about 85% of the visibly discernable electromagnetic radiation which is passed by the acceptable portion 12. The process stream 30 passes through the inspection chamber 206, and passes out through the bottom surface 204, and under the force of gravity to an ejection station or assembly 230.

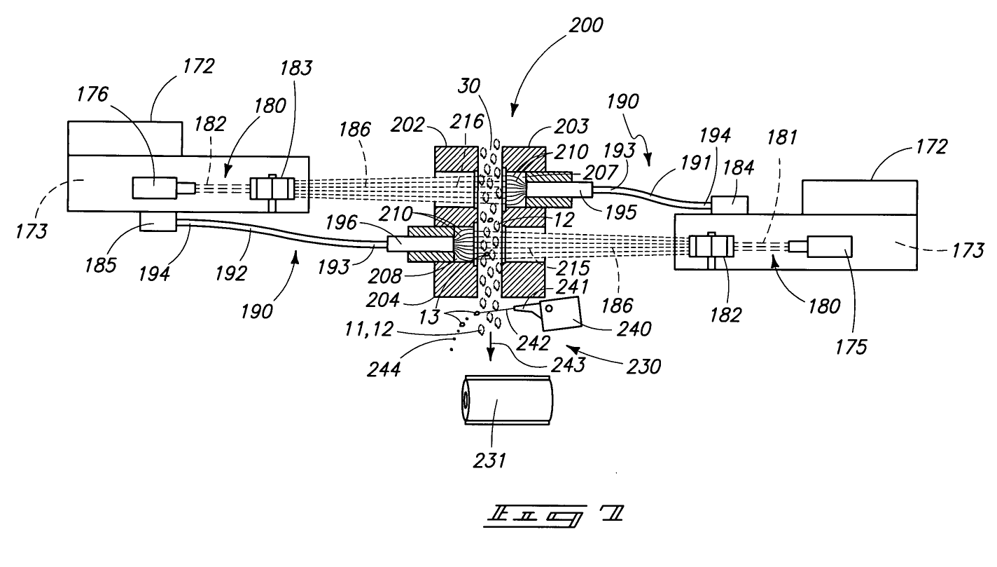

Referring now to FIG. 7, the method and apparatus 10 of the present invention includes an ejection station or assembly which is generally indicated by the numeral 230. The ejection station or assembly 230 is positioned in spaced relationship relative to the bottom surface 204, of the inspection chamber 206. Further, an acceptable product conveyor 231 is positioned therebelow the inspection station. The ejection station is operable to remove unacceptable portions 13 from the process stream 30, and which has previously passed through the inspection chamber 206. In this regard, the ejection station includes an ejector, which is in the form of an air manifold 240, and which is well known in the art. This prior art ejector includes a plurality of air outlets 241. As is well understood by those skilled in the art, a source of pressurized, selectively controllable air is provided to the individual air outlets 241 in order to provide an air blast 242 which is utilized to remove the unacceptable portions 13 from the process stream 30. As should be understood from a study of FIG. 6, the product 11 can move along a first path of travel 243 where it will be received onto the acceptable product conveyor 231, or further, can travel along a second path of travel 244, when it is diverted from the first path of travel 243 by the air blast 242 which is selectively provided by the air manifold 240. Therefore, by means of a control system which will be described below, the ejector, or air manifold 240 can be selectively employed to remove unacceptable portions 13 from the process stream 30, and which have been previously identified in the inspection chamber 206. The control system which implements the method and apparatus of the present invention will be described in greater detail in the paragraphs below.

Referring now to FIG. 8, the method and apparatus of the present invention 10 includes an electrical processing assembly which is generally indicated by the numeral 250, and which is operable to coordinate the operation of the various components and subassemblies of the present invention 10 as described in the paragraphs immediately above. In this regard, electrical processing assembly 250 includes, among other components, a general purpose computer 251, and which includes a memory 252 which contains information which facilitates the identification of unacceptable portions 13 in the process stream 30. The electrical processing assembly 250 determines the presence of the previously unidentified unacceptable portions 13 in the process stream 30 by comparing the electrical signal outputs provided by the respective electromagnetic radiation receivers 184 and 185 with information stored in the memory 252 of the electrical processing assembly 250. In determining the presence of unacceptable portion 13, the electrical processing assembly has input from the various assemblies, as described above (such as the electromagnetic radiation receivers 184 and 185), and which provides a plurality of data samples which are stored in the memory of the electrical processing assembly 250. Each data sample is created at a given time and at predetermined intervals, and each data sample is assigned a value that is approximately equal to the magnitude of the electrical signal output of the electromagnetic radiation receivers 184 and 185 at a specific time. The computer 251 is operable to calculate a mathematical average of at least two of the plurality of data samples. This same mathematical average is then stored in the memory 252 of the electrical processing assembly 250. The computer 251 thereafter utilizes the mathematical average of the at least two data samples as information stored in the memory of the electrical processing assembly and this same information facilitates the identification of the unacceptable portions 13 in the process stream. The electrical processing assembly 250 further includes a plurality of controllers which are generally indicated by the numeral 253, and which are controllably coupled by way of suitable electrical conduits or pathways 254 to the computer. The individual controllers 253 also provide data information to the computer which is necessary for the computer to assess or determine the presence of unacceptable portions 13 in the process stream 30, and further to coordinate the effective removal of the unacceptable portions 13 from the process stream either by way of the action of the first and second capture assemblies 41 and 42, or by means of the ejector which is generally indicated by the numeral 240. The individual controllers 253 are further controllably coupled by way of suitable electrical pathways 255 to the respective subassemblies of the present invention as indicated in FIG. 8. These various assemblies include, among other things, the first and second capture assemblies 41, 42; the first and second electromagnetic radiation emitters 175 and 176; the first and second rotating mirrors 182 and 183; the first and second electromagnetic radiation receivers 184 and 185; the acceptable product conveyor 231; the ejector 240; and the pump 23 which supplies the slurry of product to be sorted 11 and which forms the resulting process stream 30. Yet further, the computer 250 is electrically coupled with the pressure sensors 53 and 154, and the blockage sensors 114 and 155, respectively. In this regard, the computer upon sensing an appropriate signal output of the respective sensors causes the first and second scrapers 80 and 80A to move and thereby remove unacceptable portions 13 of the process stream which have been captured by the first and second slots 61 and 124, respectively.

### Operation

The operation of the described embodiment of the apparatus and method of the present invention 10 will become readily apparent from the description which is provided for hereinafter.

Referring now to FIG. 1, a sorting apparatus 10 is generally shown, and which includes, among other things, a product 11 to be sorted and which is formed into a process stream 30, and which includes acceptable portions 12 and unacceptable portions 13. The acceptable portions 12 of the process stream 30 have a given hardness and the unacceptable portions 13 of the process stream have a hardness which is at least about 20% greater than the hardness of the acceptable portions of the process stream. Still further, the acceptable and unacceptable portions pass given amounts of visibly discernable electromagnetic radiation 180, 181. It being understood that the acceptable portions 12 pass a greater amount of electromagnetic radiation than the unacceptable portions 13.

A first capture assembly 41 is provided and is positioned in receiving relation relative to the process stream 30. The first capture assembly has a main body 43 which defines a channel 44 having a distal or discharge end 50. Still further, the first capture assembly defines a first slot 61 having a first predetermined length and width, and which is positioned near the distal end 50. The process stream 30 having both acceptable and unacceptable portions 12 and 13 passes along the channel 44, and acceptable portions 12, and at least some unacceptable portions 13 of the process stream 30 are forcibly deformed as they pass through the first slot 61, and at least some of the unacceptable portions 13 cannot be sufficiently forcibly deformed to pass through the first slot 61. Additionally, the apparatus 10 includes a first selectively moveable scraper 80 which is borne by the first capture assembly 41, and which is operable to remove at least some of the unacceptable portions 13 which cannot pass through the first slot 61 from the process stream 30. The apparatus of the present invention 10 further includes a second capture assembly 42 which is positioned in downstream receiving relation relative to the first capture assembly 41. The second capture assembly 42 further includes a main body 120 which defines a channel 121, having a distal or discharge end 123, and a second slot 124, having a predetermined length and width and which is positioned near the distal or discharge end 123. The predetermined length and width of the second slot 124 is substantially equal to or greater than the width of the first slot 61. The process stream 30 having both acceptable 12 and unacceptable portions 13 are forcibly deformed as they pass through the second slot 124, and at least some further unacceptable portions 13 cannot be sufficiently forcibly deformed to pass through the second slot. The apparatus of the present invention 10 further includes a second selectively movable scraper 80A (FIG. 8) which is borne by the second capture assembly 42, and which is operable to remove the further unacceptable portions 13 which cannot pass through the second slot 124.

An inspection station 160 is positioned downstream of the second capture assembly 42. The inspection station defines an inspection chamber 206 through which the resulting process stream 30, which includes acceptable and unacceptable portions 12 and 13 passes. As seen in FIG. 4 an electromagnetic radiation emitter 175 is positioned in the inspection station and which produces a beam of electromagnetic radiation 180, which is partially visibly discernible, and which is transmitted at a given angle through the process stream 30 which is traveling through the inspection station 160. This relationship is also seen in FIGS. 5, 6 and 7. An electromagnetic radiation receiver or other sensor 184 is positioned in the inspection station 160, and receives at least a portion of the beam of electromagnetic radiation 180 which has passed through the process stream 30 traveling through the inspection station. The electromagnetic radiation receiver produces an electrical signal output. An electrical processing assembly 250 having a memory 252 receives the electrical signal output of the electromagnetic radiation receiver 184. The memory 252 stores information regarding acceptable and unacceptable portions 12 and 13. The electrical signal output received from the electromagnetic radiation receiver 184 is then compared to information stored in the memory to determine the presence of unacceptable portions 13 in the process stream 30 passing through the inspection station 160.

An ejector 240 (FIG. 6) is positioned downstream of the inspection station 160, and which is operable to remove any remaining unacceptable portions 13 from the process stream 30, and which has previously passed through the inspection station 160. The ejector 240 is controllably coupled to the electrical processing assembly 250. In the arrangement as seen in FIGS. 1-8, the electromagnetic radiation emitters 175 and 176 each comprise a laser which emits electromagnetic radiation having at least a portion of which is visibly discernable. Still further, in connection with the first and second capture assemblies 41 and 42, the first and second slots 61 and 124 each have a proximal, and a distal end, and the respective first and second scrapers 80 and 80A slideably and matingly cooperate with the first and second slots 61 and 124, and further selectively, and reciprocally move between the first and second ends of the respective first and second slots 61 and 124. Each of the first and second capture assemblies 41 and 42 define a discharge port 95 and 135, respectively, and which is located at the distal end of each of the respective channels, such as 70, and which is further adjacent to the first and second slots 61 and 124. Yet further, the first and second capture assemblies each include a selectively positionable discharge gate 111 and 151, respectively, and which are individually operable, in a first condition, to substantially occlude the adjacent discharge port, and in a second condition, to be located in a substantially non-occluding position relative to the adjacent discharge port 95 and 135. In the arrangement as shown, and in the second condition, the first and second selectively movably scrapers 80 and 80A are operable to remove the unacceptable portions 13 from the process stream 30, and eject them through the respective discharge ports 95 and 135.

The apparatus 10 of the present invention further includes a plurality of controllers 253 which are controllably coupled to the respective components as described, above, and further coupled and controlled by a computer 251. The respective controllers 253 are controllably coupled to the respective first and second scrapers 80 and 80A and to each of the discharge gates 111 and 151 as described, above. The respective controllers 253 coordinate the operation of the respective first and second scrapers 80 and 80A and the respective discharge gates. In this regard, the individual controllers are operable to cause the selectively positionable discharge gates 111 and 151 to move from the occluding position to the non-occluding position relative to the respective discharge ports 95 and 135 when the respective first and second scrapers 80 and 80A are located in predetermined positions relative to the respective first and second slots 61 and 124, and further as the respective first and second scrapers 80 and 80A move from the proximal end of the respective first and second slots 61 and 124 in the direction of the distal ends of the respective slots, and in the direction of the respective discharge gates. Still further, the controller may be rendered operable to periodically, and reciprocally move the first and second scrapers 80 and 80A along the respective first and second slots 61 and 124 during predetermined time intervals, and further to cause the respective first and second discharge gates 111 and 151 to move to an occluding position once the first and second scrapers 80 and 80A begin to move towards one end of the first and second slots 61 and 124, and generally in a direction away from the respective discharge gates.

A sorting apparatus 10 of the present invention further includes pressure sensors 53 and 154 and blockage sensors 114 and 155, respectively. The pressure sensors 53 and 154 are borne by the respective first and second capture assemblies 41 and 42, and are further positioned in pressure sensing relation relative to the process stream 30 which is traveling along the respective channels 44 and 121, respectively. Alternatively, the pressure sensors 53 and 154 may be positioned at other locations along the process stream including the product delivery conduit 30. The respective pressure sensors are electrically coupled to the controller 253. The individual pressure sensors provide a sensor signal to indicate the relative pressure of the process stream 30. The computer 251, and associated controller 253, in response to the received pressure sensor signal, causes the respective first and second scrapers 80 and 80A to reciprocally move along the respective first and second slots 61 and 124 when pressure of a predetermined magnitude is sensed by the respective pressure sensors. In addition to the foregoing, the blockage sensor 114 and 154 is provided, and which are borne by the respective first and second capture assemblies 41 and 42. The respective blockage sensors are positioned adjacent to one of the ends of the respective channels, such as 70, and which are defined by the respective first and second capture assemblies 41 and 42, and juxtaposed relative to the first and second slots 61 and 124, respectively. The respective blockage sensors are electrically coupled with an associated controller 253, and further provides a sensor signal when unacceptable portions 13 cannot pass through the first and second slots. In response to this sensor signal, the respective scrapers 80 and 80A are reciprocally moved to remove the undesirable and unacceptable portions 13 from the process stream 30.

The electromagnetic radiation 180 and 181 emitted by the respective electromagnetic radiation emitters 175 and 176, respectively has a wavelength of about 400-1000 nanometers. The acceptable portion 12 of the process stream 30 passes at least a portion of the visibly discernable electromagnetic radiation, and the unacceptable portion of the process stream 13 passes less than about 85% of the visibly discernable electromagnetic radiation which is passed by the acceptable portion of the same process stream. The electromagnetic radiation emitters 175 and 176 typically comprise a laser which is located in the inspection station 160, and which produces the beam of electromagnetic radiation 180 and 181, respectively. Still further, rotating mirrors 182 and 183 are provided and which directs the beam of electromagnetic radiation 180, 181 through the process stream 30 as more clearly seen in FIG. 5. In the arrangement as seen in FIG. 5, the process stream 30 passing through the inspection chamber 206 has a width dimension of less than about one inch. In a preferred embodiment, this width dimension is about ¼ inch or less. Further, and as seen in FIGS. 5 and 6, it will be understood that the inspection station 160 includes a pair of electromagnetic radiation emitters 175 and 176, respectively. In the arrangement as shown, the respective beams of electromagnetic radiation 180 and 181 pass through the process stream 30 moving in opposite directions, and are subsequently received by the electromagnetic radiation receivers 184 and 185, respectively. When two electromagnetic radiation emitters and receivers are employed, two processing signals are received by the computer 251, and can be acted upon, by the computer, to direct further functions of the apparatus and method 10.

In the method of the present invention 10, and which is understood by a study of FIGS. 1-7, the method of sorting includes a first step of providing a process stream 30 having a mixture of acceptable portions 12, having a first hardness, and which pass a predetermined amount of visible light, and unacceptable portions 13, having a second hardness, and which is greater than the first hardness, and which further passes an amount of visible light which is less than the amount of visible light which is passed by the acceptable portions. The method further includes a second step of passing the process stream 30 through an aperture 61 and 124 to forcibly deform the process stream 30 and to identify and remove at least some of the unacceptable portions 13 in the process stream 30 which cannot deform and pass through the apertures 61 and 124 because of their respective hardness, density or size. In the arrangement as shown, substantially all of the acceptable portions 12 of the process stream 30, and some remaining unacceptable portions 13 pass through the aperture 61, and form a resulting process stream 30. After the step of passing the process stream through the aperture 61, the method further includes a step of transmitting a beam of visibly discernible electromagnetic radiation 180, 181, and which has been formed into a scanned line 186 through the resulting process stream 30 to identify any remaining unacceptable portions 13 in the resulting process stream. Finally, the method of the present invention in its broadest aspect includes removing the remaining unacceptable portions 13 from the resulting process stream.

The method of sorting of the present invention further includes, in another aspect, a first step of forming a product 11 into a process stream 30 which includes acceptable and unacceptable portions 12 and 13, and further transporting the process stream 30 and passing it through a first capture assembly 41 which defines a first slot 61. The first slot 61 has a predetermined length and width dimension, and is configured to pass acceptable portions 12 of the process stream 30, and at least some of the unacceptable portions 13, and not pass at least some of the unacceptable portions 13 of the process stream 30. The method further includes the step of removing the at least some of the unacceptable portions which did not pass through the first slot 61. The method also includes a step of transporting the process stream 30 and passing it through a second capture assembly 42 which defines a second slot 124. The width of the second slot 124 is typically less than the width of the first slot 61, and the process stream 30 having both acceptable and unacceptable portions 12 and 13 passes through the second slot 124, and at least some further unacceptable portions 13 which have passed through the first slot 61 cannot pass through the second slot 124. The method further includes the step of removing the at least some of the unacceptable portions 13 which did not pass through the second slot 124. After the process stream 30 passes through the second slot 124, the method further includes the step of passing the process stream 30 through an inspection station 160. In the inspection station, the method includes a step of transmitting a beam of electromagnetic radiation 180, 181 having a given frequency, and at a given angle through the process stream 30 traveling through the inspection station 160. After transmitting the beam of electromagnetic radiation, the method includes a step of receiving a portion of the beam of electromagnetic radiation 180, 181 which has passed through the process stream 30 traveling through the inspection station 160, and converting the received portion of the electromagnetic radiation beam into an electrical signal output. Once the electrical signal output is provided, the method includes a step of comparing the electrical signal output with other information which identifies acceptable and unacceptable portions 12 and 13 to determine the presence of unacceptable portions 13 in the process stream 30 which are passing through the inspection station 160. Still further, the method includes the step of removing any remaining unacceptable portions 13 of the process stream 30 which have passed through the inspection station 160, and which have been identified by the electrical signal output.

The method of the present invention, as discussed above, includes additional steps. For example, the step of removing the at least some of the unacceptable portions 13, which did not pass through the first and second slots 61 and 124, further includes a step of providing a first and second moveable scraper 80 and 80A which are individually borne by the first and second capture assemblies 41 and 42, and which individually move along the respective first and second slots 61 and 124, respectively. The method further includes a step of providing first and second selectively moveable gates 111 and 151, and which are positioned adjacent to the first and second moveable scrapers 80 and 80A, and further providing first and second discharge ports 95 and 135 adjacent to the first and second slots 61 and 124. The first and second selectively movable gates 111 and 151 are selectively moveable relative to the respective first and second discharge ports 95 and 135. Still further, the method includes providing a controller 253 which is controllably coupled to each of the selectively moveable scrapers 80 and 80A, and the individual discharge gates 95 and 135, and which causes each of the respective moveable scrapers to move along the respective slots 61 and 124, and each of the respective discharge gates 111 and 151 to move from an occluding position relative to the respective discharge ports, to a nonoccluding position relative to the respective discharge ports. As earlier discussed, the method of the present invention includes moving the first and second selectively movable scrapers 80 and 80A in response to the controller 253, to collect the at least some of the unacceptable portions 13 of the process stream 30 which cannot pass through the first and second slots 61 and 124. Still further, the method includes moving the first and second selectively movable discharge gates 111 and 151 to the nonoccluding position relative to the respective first and second discharge ports in response to the controller 253. Still further, the method includes a step of ejecting the at least some of the unacceptable portions 13 of the process stream 30 which have been collected by the individual first and second scrapers 80 and 80A through the respective first and second discharge ports. Finally, the method includes a step of moving the first and second selectively movable discharge gates to the occluding position relative to the respective first and second discharge ports, in response to the signal from the controller 253, and as the respective scrapers 80 and 80A move in a direction away from the respective discharge ports 95 and 135.

The method of the present invention, as discussed above, and which includes the step of moving the first and second selectively movable scrapers 80 and 80A further includes the step of periodically moving each of the respective scrapers 80 and 80A along the length of the respective first and second slots 61 and 124 during given time intervals. Further, the step of moving the first and second selectively movable scrapers may also include the step of detecting the presence of the at least some of the unacceptable portions 13 that cannot pass through the first and second slots 61 and 124, and generating a signal which indicates the presence of the at least some of the unacceptable portions 13 which cannot pass through the first and second slots 61 and 124. Still further the step of individually moving the first and second selectively moveable scrapers 80 and 80A also includes providing the signal to the controller 253, and wherein the controller, in response to the signal, which is provided, moves the respective first and second scrapers along the first and second slots 61 and 124, and the first and second discharge gates 111 and 151 to the nonoccluding position relative to the respective discharge ports 95 and 135, respectively. In the method of the present invention the step of detecting the presence of the at least some of the unacceptable portions 13 in the process stream 30 further includes a step of sensing a pressure generated by the moving process stream 30 as it moves through the first and second slots 61 and 124, and wherein the at least some of the unacceptable portions 13 which cannot pass through the first and second slots increase the relative pressure of the process stream 30. The controller 253 causes the first and second scrapers 80 and 80A to move along the first and second slots 61 and 124, and the first and second discharge gates 111 and 151 to move to the nonoccluding position relative to the first and second discharge ports 95 and 135 when the sensed pressure reaches a given magnitude.

In the method of the present invention, the step of transmitting a beam of electromagnetic radiation 180, 181 further includes the step of providing a laser 175, 176 which generates a beam of electromagnetic radiation 180, 181, and providing a rotating mirror 182, 183 which reflects the beam of electromagnetic radiation and which is generated by the laser. The method further includes the step of directing the beam of electromagnetic radiation 180, 181, in a first direction, and through the process stream 30 by utilizing the respective rotating mirrors. In the method of the present invention the step of providing a laser further includes the step of providing a laser which generates a beam of electromagnetic radiation having a wavelength of about 400 to 1,000 nanometers, and more specifically a laser which generates a beam of electromagnetic radiation having a wavelength of about 532 nanometers.

In the method of the present invention the step of comparing the electrical signal output with the other information further includes the step of providing an electrical processing assembly 250 which receives the electrical signal output which has been converted from the received portion of the electromagnetic radiation 180, 181, and which has passed through the process stream 30, and wherein the electrical processing assembly 250 further includes a memory 252. The method further includes a step of providing a plurality of data samples, residing in the memory of the electrical processing assembly, and wherein each data sample is created at a given time, and at predetermined intervals. In this arrangement, each data sample is assigned a value that is approximately equal to the magnitude of the electrical signal output at a given time. The method further includes a step of calculating a mathematical average of at least two of the plurality of data samples, and wherein the mathematical average is stored in the memory 252 to facilitate the identification of unacceptable portions 13 in the product or process stream 30. In the method of the present invention the method further includes a step of providing an ejector signal to the ejector 240 in order to selectively remove unacceptable portions 13 being carried in the process stream 30 which has been passed though the inspection station 160.

In the fashion as noted above, the method and apparatus 10 of the present invention provides a very convenient way for processing a product 11 such as ground meat or poultry in a fashion which produces a uniform product having no unacceptable portions 13 contained therein, and which may include such things as bone, cartilage and natural and other man-made substances. The resulting product can thereafter be processed into various food products with a wide variety of uses.

In compliance with the statute, the invention has been described in language more or less specific as to structural and methodical features. It is to be understood, however, that the invention is not limited to the specific features shown and described, since the means herein disclosed comprise preferred forms of putting the invention into effect. The invention is, therefore, claimed in any of its forms or modifications within the proper scope of the appended claims appropriately interpreted in accordance with the doctrine of equivalents.

1. A sorting apparatus, comprising:
a product which is formed into a process stream and which includes acceptable and unacceptable portions, and which further moves along a course of travel where the product is forcibly deformed;
an inspection station positioned along the course of travel and through which the process stream, which has been previously forcibly deformed, passes;
an electromagnetic radiation emitter which produces a beam of electromagnetic radiation having a portion that is visibly discernible, and wherein the beam of electromagnetic radiation passes through the process stream as it moves along the course of travel and through the inspection station;
an electromagnetic radiation receiver which receives at least a portion of the beam of electromagnetic radiation which has passed through the process stream, and which produces an electrical signal output;
an electrical processing assembly electrically coupled to the electromagnetic radiation receiver and which processes the electrical signal output to determine the presence of unacceptable portions in the process stream; and
an ejector positioned downstream of the inspection station and which is controllably coupled to the electrical processing assembly, and which removes the unacceptable portions from the process stream.

2. A sorting apparatus as claimed in claim 1, and wherein the acceptable portion of the process stream has a given hardness, and which further passes a predetermined amount of the visibly discernible portion of the electromagnetic radiation which has been emitted, and wherein the unacceptable portion of the process stream has a hardness which is at least about 20% greater than hardness of the acceptable portion of the process stream, and further passes an amount of the visibly discernible portion of the electromagnetic radiation which is less than the amount of electromagnetic radiation which is passed by the acceptable portion of the process stream.

3. A sorting apparatus as claimed in claim 2, and further comprising:
a capture assembly positioned along the course of travel and upstream of the inspection station, and wherein the capture assembly defines a channel having a distal end, and a slot having a length dimension and which is positioned near the distal end and through which the process stream passes, and wherein the acceptable portions, and at least some of the unacceptable portions of the process stream are forcibly deformed as they pass through the slot, and at least some of the unacceptable portions cannot pass through the slot; and
a selectively moveable scraper borne by the capture assembly and which moves along the slot to remove the at least some of the unacceptable portions which cannot pass through the slot.

4. A sorting apparatus as claimed in claim 3, and wherein the capture assembly further defines a discharge port which is located near the distal end of the channel, and wherein the apparatus further comprises:
a selectively moveable discharge gate which is borne by the capture assembly and which is operable to selectively occlude the discharge port when the scraper is not moving, and further moves to a nonoccluding position relative to the discharge port to allow for the unacceptable portions to be ejected when the scraper moves along the length of the slot.

5. A sorting apparatus as claimed in claim 4, and further comprising:
a controller electrically coupled with the electrical processing assembly and further controllably coupled to the scraper and the discharge gate, and wherein the controller coordinates the operation of the moveable scraper and the discharge gate.

6. A sorting apparatus as claimed in claim 5, and wherein the moveable scraper reciprocally moves along the length of slot, and wherein the controller causes the selectively moveable discharge gate to move to the occluding position when the moveable scraper is traveling in a direction away from the discharge port, and to move to the nonoccluding position when the moveable scraper is traveling in a direction toward the discharge port and is located in a given position relative to the slot.

7. A sorting apparatus as claimed in claim 5, and wherein the controller causes the moveable scraper to reciprocally move along the slot during periodic time intervals.

8. A sorting apparatus as claimed in claim 5, and further comprising:
a blockage sensor borne by the capture assembly and which is electrically coupled with the controller, and which produces a sensor signal when unacceptable portions cannot pass through the slot, and wherein the controller in response to the sensor signal causes the moveable scraper to move across the length of the slot to remove the unacceptable portions that cannot pass therethrough and eject the unacceptable portions through the discharge port.

9. A sorting apparatus as claimed in claim 5, and wherein pressure is applied to the process stream to move the process stream along the course of travel and through the capture assembly, and where at least the acceptable portion of the process stream is forcibly deformed, and wherein the sorting apparatus further comprises:
a pressure sensor disposed in pressure sensing relation relative to the process stream which is passing along the channel of the capture assembly, and wherein the unacceptable portions which cannot pass through the slot cause the pressure of the process stream to increase, and wherein the pressure sensor produces a pressure sensor output, and wherein the controller receives the pressure sensor output and causes the moveable scraper to move along the slot and remove the unacceptable portions which cannot pass through the slot when the pressure exceeds a given magnitude.

10. A sorting apparatus as claimed in claim 1, and wherein the inspection station has first and second spaced sidewalls which define an inspection chamber, and wherein the previously deformed process stream passes through the inspection chamber, and wherein the respective sidewalls each pass the emitted electromagnetic radiation.

11. A sorting apparatus as claimed in claim 1, and wherein the beam of electromagnetic radiation is produced by a laser, and wherein a rotating mirror is provided in the inspection station, and which directs the beam of electromagnetic radiation through the process stream, and wherein the wavelength of the emitted electromagnetic radiation generated by the laser is about 400 nm. to about 1000 nm.

12. A sorting apparatus as claimed in claim 10, and wherein the electromagnetic radiation emitter is positioned near the first sidewall, and the electromagnetic radiation receiver is positioned near the second sidewall, and wherein the first and second sidewalls are spaced apart by a distance of less than about one inch.

13. A sorting apparatus as claimed in claim 12, and further comprising:
a second electromagnetic radiation emitter which is positioned near the second sidewall, and a second electromagnetic radiation receiver which is positioned near the first sidewall, and wherein the second electromagnetic radiation emitter emits a beam of electromagnetic radiation having a portion which is visibly discernible, and wherein the beam of electromagnetic radiation passes through the process stream and is received, at least in part, by the second electromagnetic radiation receiver, and wherein the second electromagnetic radiation receiver produces a second electrical signal output which is supplied to the electrical processing assembly.

14. A sorting apparatus as claimed in claim 13, and wherein the electrical processing assembly includes a memory having stored information and which relates to the identification of unacceptable portions in the process stream, and wherein the first and second electrical signal outputs provided by the respective electromagnetic radiation receivers are compared to the information stored in the memory to make a determination of the presence of an unacceptable portion in the process stream.

15. A sorting apparatus, comprising:
a product which is formed into a process stream and which includes an acceptable portion having a hardness, and which passes an amount of visibly discernible electromagnetic radiation, and an unacceptable portion having a hardness which is at least about 20% greater than the hardness of the acceptable portion, and which passes an amount of visibly discernible electromagnetic radiation which is less than the amount of visibly discernible electromagnetic radiation which is passed by the acceptable portion;
a capture assembly defining a channel having a distal end, and wherein a slot is formed in the capture assembly, and is positioned adjacent to the distal end of the channel, and wherein the process stream passes along the channel to the distal end thereof, and wherein the acceptable portions, and at least some of the unacceptable portions of the process stream, are forcibly deformed and pass through the slot, and at least some of the unacceptable portions cannot be forcibly deformed, and do not pass through the slot;
a selectively moveable scraper borne by the capture assembly and which is operable to remove the at least some of the unacceptable portions which cannot pass through the slot from the process stream;
an inspection station positioned downstream of the capture assembly and through which the process stream having the acceptable and unacceptable portions passes;
an electromagnetic radiation emitter positioned in the inspection station, and which produces an electromagnetic radiation beam having a portion which is visibly discernible, and which is transmitted through the previously deformed process stream which is passing through the inspection station;
an electromagnetic radiation receiver positioned in the inspection station and which receives at least a portion of the beam of electromagnetic radiation which has passed through the process stream which is passing through the inspection station, and wherein the electromagnetic radiation emitter produces an electrical signal output when unacceptable portions pass through the inspection station;
an electrical processing assembly which receives the electrical signal output of the electromagnetic radiation receiver, and which determines, based upon the electrical signal output, whether an unacceptable portion has passed through the inspection station; and
an ejector positioned downstream of the inspection station and which removes any remaining unacceptable portions from the process stream, and wherein the ejector is controllably coupled to the electrical processing assembly.

16. A sorting apparatus as claimed in claim 15, and wherein the unacceptable portion of the process stream passes less than about 85% of the visibly discernible portion of the electromagnetic radiation which is passed by the acceptable portion of the process stream.

17. A sorting apparatus as claimed in claim 16, and wherein the channel of the capture assembly has a proximal end, and a width dimension, and wherein the channel diminishes in its respective width dimension when measured in a direction extending from the proximal to the distal end thereof.

18. A sorting apparatus as claimed in claim 16, and wherein the slot has opposite ends, and wherein the scraper matingly cooperates with the slot.

19. A sorting apparatus as claimed in claim 16, and wherein the capture assembly further defines a discharge port which is located near one of the ends of the slot, and wherein the sorting apparatus further comprises:
a selectively positionable discharge gate borne by the capture assembly and which is operable to selectively occlude the discharge port when the scraper is not moving, and which further moves to a nonoccluding position relative to the discharge port to allow unacceptable portions to be ejected through the discharge port when the scraper moves.

20. A sorting apparatus as claimed in claim 19, and further comprising:
a controller which is controllably coupled to the scraper, and the discharge gate, and which coordinates the operation of the moveable scraper and the discharge gate.

21. A sorting apparatus as claimed in claim 20, and wherein the scraper reciprocally moves between the opposite ends of the slot, and wherein the controller causes the selectively positionable discharge gate to move between the occluding and nonoccluding positions relative to the discharge port when the moveable scraper is in a predetermined position and/or moving in a predetermined direction relative to the slot.

22. A sorting apparatus as claimed in claim 20, and wherein the controller causes the selectively positionable discharge gate to move to the occluding position when the moveable scraper is moving in a direction away from the discharge port, and to move to the nonoccluding position when the moveable scraper is located approximately midway between the opposite ends of the slot, and further is moving in the direction of the discharge port.

23. A sorting apparatus as claimed in claim 20, and wherein the controller causes the moveable scraper to reciprocally move along the slot during periodic time intervals.

24. A sorting apparatus as claimed in claim 23, and further comprising:
a blockage sensor borne by the capture assembly and which is electrically coupled with the controller, and wherein the blockage sensor provides a sensor signal when unacceptable portions cannot pass and/or block a portion of the slot, and wherein the controller in response to the sensor signal causes the scraper to move and remove the unacceptable portions which cannot pass and/or which block a portion of the slot.

25. A sorting apparatus as claimed in claim 23, and further comprising:
a pressure sensor borne by the capture assembly and which senses a pressure which is generated by the process stream as the process stream moves along the channel, and wherein the pressure sensor is electrically coupled to the controller, and further produces a pressure sensor signal when the pressure generated by the process stream exceeds a given magnitude, and which is caused by the unacceptable portions which cannot pass through the slot, and which are blocking a portion of the slot, and wherein the controller upon receiving the pressure sensor signal causes the scraper to move along the slot, and remove any unacceptable portions which cannot pass through the slot.

26. A sorting apparatus as claimed in claim 16, and wherein the wavelength of the emitted electromagnetic radiation is about 400 to about 1000 nm, and wherein the electromagnetic radiation emitter is a laser.

27. A sorting apparatus as claimed in claim 16, and wherein the beam of electromagnetic radiation is produced by a laser which is positioned in the inspection station; and wherein a rotating mirror is positioned in the inspection station, and which receives and directs the beam of emitted electromagnetic radiation through the process stream which is passing through the inspection station.

28. A sorting apparatus as claimed in claim 16, and wherein the inspection station further includes an inspection chamber having opposite, spaced, first and second sidewalls, and between which the process stream passes, and wherein the respective first and second sidewalls are each operable to pass the emitted electromagnetic radiation.

29. A sorting apparatus as claimed in claim 28, and wherein the electromagnetic radiation emitter is positioned adjacent to the first sidewall, and the electromagnetic radiation receiver is positioned near the second sidewall, and wherein the sorting apparatus further comprises:
a second electromagnetic radiation emitter positioned near the second sidewall, and which emits a second beam of electromagnetic radiation having a portion which is visibly discernible, and which passes through the respective sidewalls, and through the process stream passing through the inspection chamber; and
a second electromagnetic radiation receiver positioned near the first sidewall and which receives at least a portion of the second beam of electromagnetic radiation which has passed through the process stream, and which produces a second electrical signal output as the process stream passes through the inspection chamber, and wherein the second electromagnetic radiation emitter and receiver are electrically coupled with the electrical processing assembly.

30. A sorting apparatus as claimed in claim 29, and wherein the electrical processing assembly utilizes the first and second electrical signal outputs of the respective first and second electromagnetic radiation receivers to determine the presence of unacceptable portions in the process stream which is passing through the inspection chamber.

31. A sorting apparatus as claimed in claim 30, and wherein the electrical processing assembly further includes a memory having stored information which relates to the determination of the presence of unacceptable portions in the processing stream, and wherein the electrical processing assembly compares the first and second electrical signal outputs to the information stored in memory.

32. A sorting apparatus as claimed in claim 31, and wherein the memory further has an electrical signal output threshold, and wherein an electrical signal output greater than the electrical signal output threshold indicates the presence of an unacceptable portion in the process stream, and wherein the electrical processing assembly computes an average magnitude of the first and second electrical signal outputs over a period of time, and then uses the average magnitude to determine if the electrical signal output threshold has been exceeded.

33. A sorting apparatus as claimed in claim 16, and wherein the electromagnetic radiation has a wavelength of about 532 nm, and wherein the electromagnetic radiation emitter is a laser.

34. A sorting apparatus as claimed in claim 16, and wherein the beam of electromagnetic radiation has a diameter of greater than about 0.1 mm.

35. A sorting apparatus as claimed in claim 16, and wherein the process stream passing through the inspection station has a width dimension of less than about ¼ inch.

36. A sorting apparatus as claimed in claim 16, and further comprising:
an optical fiber having a first end positioned in the inspection station, and which is operable to receive the emitted electromagnetic radiation which has passed through the process stream, and an opposite second end which is optically coupled to the electromagnetic radiation receiver, and wherein the emitted electromagnetic radiation which has passed through the process stream travels along the optical fiber and is received by the electromagnetic radiation receiver.

37. A sorting apparatus as claimed in claim 36, and wherein a plurality of optical fibers are oriented to receive the emitted electromagnetic radiation which has passed through the process stream, and wherein the respective optical fibers are arranged in at least one row, and wherein the first end of the respective optical fibers are oriented in a substantially transverse relationship relative to the direction of travel of the process stream through the inspection station.

38. A sorting apparatus as claimed in claim 37, and wherein the electromagnetic radiation receiver provides a single electrical signal output which is a summation of the emitted electromagnetic radiation received from the second end of each of the optical fibers.

39. A sorting apparatus, comprising:
a product which is formed into a process stream and which includes acceptable and unacceptable portions;
a first capture assembly positioned in receiving relation relative to the process stream, and which includes a main body which defines a channel having a distal end, and a first slot having a first predetermined length and width, and which is positioned near the distal end, and wherein the process stream having both acceptable and unacceptable portions passes along the channel, and acceptable portions, and at least some of the unacceptable portions of the process stream, are forcibly deformed as they pass through the first slot, and at least some of the unacceptable portions cannot be sufficiently forcibly deformed to pass through the first slot;
a first selectively moveable scraper borne by the first capture assembly and which is operable to remove the at least some of the unacceptable portions which cannot pass through the first slot from the process stream;
a second capture assembly positioned in downstream receiving relation relative to the first capture assembly, and which further includes a main body which defines a channel having a distal end, and a second slot having a predetermined length, and width and which is positioned near the distal end thereof, and wherein the predetermined width of the second slot is equal to or greater than the width of the first slot, and wherein the process stream having both acceptable and unacceptable portions are forcibly deformed as they pass through the second slot, and at least some further unacceptable portions cannot be sufficiently forcibly deformed to pass through the second slot;
a second selectively moveable scraper borne by the second capture assembly, and which is operable to remove the further unacceptable portions which cannot pass through the second slot;
an inspection station positioned downstream of the second capture assembly, and which defines an inspection chamber through which the resulting process stream which includes acceptable and unacceptable portions passes;
an electromagnetic radiation emitter positioned in the inspection station and which produces a beam of electromagnetic radiation which is at least partially visibly discernible, and which is transmitted at a given angle through the process stream which is traveling through the inspection station;
an electromagnetic radiation receiver positioned in the inspection station, and which receives at least a portion of the beam of electromagnetic radiation which has passed through the process stream traveling through the inspection station, and wherein the electromagnetic radiation receiver produces an electrical signal output;
an electrical processing assembly having a memory and which receives the electrical signal output of the electromagnetic radiation receiver, and wherein the memory stores information regarding acceptable and unacceptable products, and wherein the electrical signal output received from the electromagnetic radiation receiver is compared to the information stored in the memory to determine the presence of unacceptable portions in the process stream passing through the inspection station; and
an ejector positioned downstream of the inspection station and which is operable to remove any remaining unacceptable portions of the process stream which has passed through the inspection station, and wherein the ejector is controllably coupled to the electrical processing assembly.

40. A sorting apparatus as claimed in claim 39, and wherein the acceptable portion of the process stream has a given hardness, and wherein the unacceptable portion of the process stream has a hardness which is at least about 20% greater than the hardness of the acceptable portion of the process stream.

41. A sorting apparatus as claimed in claim 40, and wherein the respective channels of the first and second capture assemblies each have a proximal end, and a width dimension, and wherein the respective channels diminish in their respective width dimensions when measured in a direction extending from the proximal to the distal end.

42. A sorting apparatus as claimed in claim 40, and wherein the electromagnetic radiation emitter is a laser.

43. A sorting apparatus as claimed in claim 40, and wherein the respective first and second slots each have a proximal and distal end, and a length dimension, and wherein the respective first and second scrapers matingly cooperate with the respective first and second slots and selectively and reciprocally move between the first and second ends of the respective first and second slots.

44. A sorting apparatus as claimed in claim 40, and wherein each of the first and second capture assemblies define a discharge port which is located at the distal end of each of the respective channels, and adjacent to the first and second slots, and wherein the sorting apparatus further comprises:
a selectively positionable discharge gate borne by the respective first and second capture assemblies and which is operable, in a first condition, to substantially occlude the discharge port, and in a second condition, to be in a substantially nonoccluding position relative to the discharge port, and wherein in the second condition the first and second selectively moveable scrapers are operable to remove the unacceptable portions from the process stream and eject them through the respective discharge ports.

45. A sorting apparatus as claimed in claim 44 and further comprising:
a controller controllably coupled to the respective first and second scrapers and each of the discharge gates, and which coordinates the operation of the respective first and second scrapers and the respective discharge gates.

46. A sorting apparatus as claimed in claim 45, and wherein the first and second slots each have a proximal and a distal end, and wherein the respective first and second scrapers reciprocally move between the first and second ends of the respective first and second slots, and wherein the controller causes the selectively positionable discharge gates to move from the occluding position to the nonoccluding position relative to the respective discharge ports when the respective first and second scrapers are located in a predetermined position relative to the respective first and second slots, and as the respective first and second scrapers move from the proximal end of the respective first and second slots in the direction of the distal end of the respective slots.

47. A sorting apparatus as claimed in claim 46, and wherein the controller causes the selectively positionable discharge gates to be positioned in the occluding position relative to the respective discharge ports as the respective first and second scrapers move under the influence of the controller from the distal end of the respective first and second slots in the direction of the proximal end thereof.

48. A sorting apparatus as claimed in claim 45, and wherein the controller causes the respective first and second scrapers to reciprocally move along the respective first and second slots during predetermined periodic time intervals.

49. A sorting apparatus as claimed in claim 45, and further comprising:
a blockage sensor borne by the respective first and second capture assemblies, and which is positioned adjacent to the distal end of the channel, and juxtaposed relative to the respective first and second slots, and wherein the blockage sensor is electrically coupled with the controller, and provides a sensor signal when unacceptable portions cannot pass through the first and second slots.

50. A sorting apparatus as claimed in claim in claim 45, and further comprising:
a pressure sensor positioned in pressure sensing relation relative to the process stream traveling along the respective channels as defined by the respective first and second capture assemblies, and wherein the respective pressure sensors are electrically coupled to the controller, and further provides a sensor signal to indicate the pressure of the process stream, and wherein the controller causes the respective first and second scrapers to selectively reciprocally move along the respective first and second slots when pressure of a predetermined magnitude is sensed by the respective pressure sensors.

51. A sorting apparatus as claimed in claim 40, and wherein the electromagnetic radiation has a wavelength of about 400 to about 1000 nm, and wherein the acceptable portion of the process stream passes at least a portion of the visibly discernible electromagnetic radiation, and wherein the unacceptable portion of the process stream passes less than about 85% of the visibly discernible electromagnetic radiation which is passed by the acceptable portion of the process stream.

52. A sorting apparatus as claimed in claim 51, and further comprising:
a laser which is located adjacent to the inspection station, and which produces the beam of electromagnetic radiation; and
a rotating mirror positioned in the inspection station and which directs the beam of electromagnetic radiation through the process stream.

53. A sorting apparatus as claimed in claim 40, and wherein the inspection station defines an inspection chamber through which the process stream passes, and which is operable to pass the electromagnetic radiation beam.

54. A sorting apparatus as claimed in claim 53, and wherein the process stream passing through the inspection chamber has a width dimension of less than about one inch.

55. A sorting apparatus as claimed in claim 40, and further comprising:
an inspection chamber defined by the inspection station, and through which the previously deformed process stream passes, and wherein the process stream passing through the inspection station has opposite first and second sides, and wherein the electromagnetic radiation emitter is positioned adjacent to the first side of the process stream and the electromagnetic radiation receiver is positioned adjacent to the second side of the process stream, and wherein the sorting apparatus further comprises:
a second electromagnetic radiation emitter positioned adjacent to the second side of the process stream and which, when energized, emits a beam of electromagnetic radiation which is transmitted through the process stream; and
a second electromagnetic radiation receiver positioned adjacent to the first side of the process stream, and which receives at least a portion of the beam of electromagnetic radiation which has passed through the process stream, and which further produces a second electrical signal output, and wherein the second electromagnetic radiation emitter and receiver are electrically coupled with the electrical processing assembly.

56. A sorting apparatus as claimed in claim 55, and wherein the electrical processing assembly utilizes the electrical signal outputs of the respective electromagnetic radiation receivers and compares the respective electrical signal outputs to the information stored in memory to determine the presence of unacceptable portions in the process stream.

57. A method of sorting, comprising:
providing a product having acceptable and unacceptable portions and forming the product into a moving process stream;
deforming the moving process stream to identify at least some of the unacceptable portions in the moving process stream;
after the step of deforming the process stream, removing the at least some of the identified unacceptable portions from the process stream;
after the step of removing the at least some of the identified unacceptable portions, identifying any remaining unacceptable portions in the process stream by passing a beam of electromagnetic radiation having a visibly discernible portion through the moving process stream; and
removing any remaining unacceptable portions identified by the beam of electromagnetic radiation from the moving process stream.

58. A method of sorting as claimed in claim 57, and wherein the step of deforming the process stream further comprises:
passing the process stream through a slot having a predetermined length, and width dimension, and wherein the acceptable portions and at least some of the unacceptable portions pass through the slot, and wherein at least some of the unacceptable portions cannot pass through the slot.

59. A method as claimed in claim 58, and wherein the step of removing the at least some of the identified unacceptable portions from the process stream further comprises:
removing the at least some of the unacceptable portions which cannot pass through the slot.

60. A method of sorting as claimed in claim 59, and further comprising:
providing a selectively moveable scraper which cooperates with the slot;
providing a discharge port which is positioned adjacent to the slot;
providing a selectively moveable discharge gate which is selectively moveable relative to the discharge port; and
providing a controller which is controllably coupled to each of the selectively moveable scraper and the discharge gate, and which causes the moveable scraper to move along the slot, and the discharge gate to move from an occluding position relative to the discharge port, to a nonoccluding position relative to the discharge port.

61. A method of sorting as claimed in claim 60, and further comprising:
moving the selectively moveable scraper along the length of the slot, in response to the controller, to collect the at least some of the unacceptable portions of the process stream which cannot pass through the slot;
moving the selectively moveable discharge gate to the nonoccluding position relative to the discharge port, in response to the controller;
ejecting the at least some of the unacceptable portions of the process stream which have been collected by the scraper through the discharge port; and
moving the selectively moveable discharge gate to the occluding position relative to the discharge port, in response to the controller.

62. A method of sorting as claimed in claim 61, and wherein the step of moving the selectively moveable scraper further comprises:
periodically moving the scraper along the length of the slot during given time intervals.

63. A method of sorting as claimed in claim 61, and wherein before the step of moving the selectively moveable scraper, the method further comprises:
detecting the presence of the at least some of the unacceptable portions which cannot pass through the slot;
generating a signal which indicates the presence of the at least some of the unacceptable portions which cannot pass through the slot; and
providing the generated signal to the controller, and wherein the controller, in response to the generated signal, which is provided, moves the scraper along the slot, and the discharge gate to the nonoccluding position relative to the discharge port.

64. A method as claimed in claim 63, and wherein the step of detecting the presence of the at least some of the unacceptable portions further comprises:
sensing a pressure generated by the moving process stream as it moves through the slot, and wherein the at least some of the unacceptable portions which cannot pass through the slot increase the relative pressure of the process stream, and wherein the controller causes the scraper to move along the slot, and the discharge gate to move to the nonoccluding position relative to the discharge port when the sensed pressure reaches a given magnitude.

65. A method as claimed in claim 57, and wherein the step of identifying any remaining unacceptable portions in the process stream further comprises:
providing a first laser which generates the beam electromagnetic radiation;
providing a first rotating mirror and which is operable to reflect the beam of electromagnetic radiation which is generated by the first laser; and
directing the beam of electromagnetic radiation, in a first direction, and through the process stream by utilizing the first rotating mirror.

66. A method of sorting as claimed in claim 65, and further comprising:
providing a second laser which generates a beam of electromagnetic radiation;
providing a second rotating mirror and which is operable to reflect the beam of electromagnetic radiation which is generated by the second laser; and
directing the beam of electromagnetic radiation generated by the second laser, in a second direction, and through the process stream, by utilizing the second rotating mirror, and wherein the first and second directions are substantially opposite.

67. A method of sorting as claimed in claim 57, and wherein the step of identifying any remaining unacceptable portions of the process stream further comprises:
providing an electromagnetic radiation receiver which is configured to receive at least a portion of the beam of electromagnetic radiation which has passed through the process stream, and which generates an electrical signal output;
providing an electrical processing assembly, and which is coupled in electrical signal receiving relation relative to the electromagnetic radiation receiver, and wherein the electrical processing assembly further includes a memory which contains information which permits the identification of unacceptable portions in the process stream; and
determining the presence of at least some of the unacceptable portions in the process stream by comparing the electrical signal output of the electromagnetic radiation receiver with the information stored in the memory of the electrical processing assembly.

68. A method of sorting, comprising:
providing a product having an acceptable portion with a first hardness and an unacceptable portion having a second hardness, and wherein the second hardness is greater than the first hardness, and forming the product into a process stream;
moving the process stream along a course of travel;
deforming the process stream to identify at least some of the unacceptable portions of the process stream having the second hardness;
removing the at least some of the unacceptable portions of the process stream which have been identified by deforming the process stream;
passing at least a portion of a beam of electromagnetic radiation through the remaining process stream, and which includes acceptable portions which pass an amount of the electromagnetic radiation, and unidentified unacceptable portions which pass an amount of the electromagnetic radiation which is less than that passed by the acceptable portions, as the remaining process stream continues to move along the course of travel;
receiving the portion of the beam of electromagnetic radiation which has passed through the remaining process stream having acceptable portions and unidentified unacceptable portions;
determining the presence of the previously unidentified unacceptable portions of the moving process stream based upon the received portion of the beam of electromagnetic radiation which has passed through the moving process stream; and
removing the remaining unacceptable portions from the moving process stream.

69. A method of sorting as claimed in claim 68, and wherein the step of deforming the process stream further comprises:
passing the process stream through a first slot having a predetermined length and width dimension, and wherein the acceptable portions and at least some of the unacceptable portions pass through the slot, and wherein at least some unacceptable portions cannot pass through the first slot.

70. A method of sorting as claimed in claim 69, and wherein the step of removing the at least some of the unacceptable portions which have been identified by deforming the process stream further comprises:
removing the at least some of the unacceptable portions which cannot pass through the first slot.

71. A method of sorting as claimed in claim 70, and further comprising:
providing a selectively movable scraper which cooperates with the first slot;
providing a discharge port which is positioned adjacent to the first slot;
providing a selectively movable discharge gate which is selectively moveable relative to the discharge port; and
providing a controller which is controllably coupled to each of the selectively moveable scraper and the discharge gate, and which causes the moveable scraper to move along the first slot, and the discharge gate to move from an occluding position relative to the discharge port, to a substantially nonoccluding position relative to the discharge port.

72. A method of sorting as claimed in claim 71, and further comprising:
moving the selectively movable scraper along the length of the first slot in response to the controller, to collect the at least some of the unacceptable portions of the process stream which cannot pass through the first slot;
moving the selectively movable discharge gate to the nonoccluding position relative to the discharge port, in response to the controller, as the selectively moveable scraper moves toward the discharge port;
ejecting the at least some of the unacceptable portions of the process stream which have been collected by the scraper through the discharge port; and
moving the selectively movable discharge gate to the occluding position relative to the discharge port, in response to the controller, and as the selectively moveable scraper moves away from the discharge port.

73. A method of sorting as claimed in claim 72, and wherein before the step of moving the selectively moveable scraper, the method further comprises:
detecting the presence of the at least some of the unacceptable portions that cannot pass through the first slot; and
generating a signal which indicates the presence of the at least some of the unacceptable portions which cannot pass through the first slot; and
providing the signal to the controller, and wherein the controller, in response to the signal, which is provided, moves the scraper along the first slot, and the discharge gate to the nonoccluding position relative to the discharge port, and wherein the discharge gate does not move to the nonoccluding position until the moveable scraper is positioned about midway along the length of the slot.

74. A method of sorting as claimed in claim 68, and wherein the step of determining the presence of the previously unidentified unacceptable portions in the remaining process stream further comprises:
providing a first laser which generates a beam of electromagnetic radiation;
providing a first rotating mirror, and which is operable to reflect the beam of electromagnetic radiation which is generated by the first laser; and
directing the beam of electromagnetic radiation, in a first direction, and through the process stream by utilizing the first rotating mirror, and wherein the first direction is substantially perpendicular to the process stream.

75. A method of sorting as claimed in claim 74, and further comprising:
providing a second laser which generates a beam of electromagnetic radiation;
providing a second rotating mirror and which is operable to reflect the beam of electromagnetic radiation which is generated by the second laser; and
directing the beam of electromagnetic radiation generated by the second laser, in a second direction, and through the process stream, by utilizing the second rotating mirror, and wherein the first and second directions of the respective electromagnetic radiation beams are substantially parallel to each other.

76. A method of sorting as claimed in claim 68, and wherein the step of receiving the portion of the beam of electromagnetic radiation further comprises:
providing an electromagnetic radiation receiver which is configured to receive a portion of the beam of electromagnetic radiation which has passed through the process stream, and which generates an electrical signal output having a magnitude.

77. A method of sorting as claimed in claim 76, and wherein the step of determining the presence of the previous unidentified unacceptable portions of the process stream further comprises:
providing an electrical processing assembly, and which is coupled in electrical signal receiving relation relative to the electromagnetic radiation receiver, and wherein the electrical processing assembly further includes a memory which contains information which facilitates the identification of unacceptable portions in the process stream; and
determining the presence of the previously unidentified unacceptable portions in the process stream by comparing the electrical signal output of the electromagnetic radiation receiver with the information stored in the memory of the electrical processing assembly.

78. A method of sorting as claimed in claim 77, and further comprising:
providing a plurality of data samples which are stored in the memory of the electrical processing assembly, and wherein each data sample is created at a given time and at a predetermined intervals, and wherein each data sample is assigned a value that is approximately equal to the magnitude of the electrical signal output of the electromagnetic radiation receiver at the specific time;
calculating a mathematical average of at least two of the plurality of data samples, and wherein the mathematical average is stored in the memory of the electrical processing assembly; and
utilizing the mathematical average of the at least two data samples as information stored in the memory of the electrical processing assembly, and which facilitates the identification of unacceptable portions in the process stream.

79. A method of sorting as claimed in claim 75, and further comprising:
providing an optical fiber bundle, having a plurality of individual optical fibers which are arranged within an outer sheath, and wherein the optical fiber bundle has a first end and an opposite second end, and wherein the individual optical fibers which are located at the first end are arranged in at least one row which has a length dimension, and wherein the second end of the respective optical are each coupled to the electromagnetic radiation receiver;
orienting the length dimension of the first end of the optical fiber bundle in a substantially transverse direction relative to the course of travel of the process stream; and
placing the first end of the optical fiber bundle adjacent to the process stream and in receiving relation to the portion of the beam of electromagnetic radiation which has passed through the process stream.

80. A method of sorting as claimed in claim 68, and further comprising:
passing the process stream through a second slot having a predetermined length and width dimension, and wherein the width of the second slot is substantially equal to or greater than the width of the first slot, and wherein the acceptable portions, and other unacceptable portions which have previously been forcibly deformed, are again forcibly passed through the second slot, and wherein at least some of the previously unidentified unacceptable portions which have passed through the first slot cannot pass through the second slot; and
removing the at least some of the previously unidentified unacceptable portions which cannot pass through the second slot.

81. A method of sorting, comprising:
forming a product into a process stream which includes acceptable and unacceptable portions;
transporting the process stream through a first capture assembly which defines a first slot;
passing the process stream through the first slot, and wherein the first slot has a predetermined length and width dimension, and is configured to pass acceptable portions of the process stream, and at least some of the unacceptable portions, and not pass at least some unacceptable portions of the process stream;
removing the at least some of the unacceptable portions which did not pass through the first slot;
transporting the process stream through a second capture assembly which defines a second slot;
passing the process stream through the second slot, and wherein the second slot has a predetermined length and width dimension, and wherein the width of the second slot is substantially equal to or greater than the width of the first slot, and wherein the process stream having both acceptable and unacceptable portions passes through the second slot, and at least some further unacceptable portions which have passed through the first slot cannot pass through the second slot;
removing the at least some of the unacceptable portions which did not pass through the second slot;
passing the process stream through an inspection station;
transmitting a beam of electromagnetic radiation having a given wavelength and at a given angle through the process stream traveling through the inspection station;
receiving a portion of the beam of electromagnetic radiation which has passed through the process stream traveling through the inspection station, and converting the received portion of the electromagnetic radiation beam into an electrical signal output;
comparing the electrical signal output with other information which identifies acceptable and unacceptable portions to determine the presence of unacceptable portions in the process stream and which are passing through the inspection station; and
removing any remaining unacceptable portions of the process stream which have passed through the inspection station and which have been identified by the electrical signal output.

82. A method of sorting as claimed in claim 81, and wherein the steps of removing the at least some of the unacceptable portions which did not pass through the first and second slots further comprises:
providing a first and second moveable scraper which are individually borne by the first and second capture assemblies, and which individually move along the respective first and second slots;
providing first and second selectively moveable gates positioned adjacent to the first and second moveable scrapers;
providing first and second discharge ports which are respectively positioned adjacent to the first and second slots, and wherein the first and second selectively movable gates are selectively moveable relative to the respective first and second discharge ports; and
providing a controller which is controllably coupled to each of the selectively moveable scrapers and the discharge gates, and which causes each of the respective moveable scrapers to move along each of the respective slots, and each of the respective discharge gates to move from an occluding position relative to the respective discharge ports, to a nonoccluding position relative to the respective discharge ports.

83. A method of sorting as claimed in claim 82, and further comprising:
moving the first and second selectively movable scrapers in response to the controller, to collect the at least some of the unacceptable portions of the process stream which cannot pass through the first and second slots;
moving the first and second selectively movable discharge gates to the nonoccluding position relative to the respective first and second discharge ports in response to the controller;
ejecting the at least some of the unacceptable portions of the process stream which have been collected by the individual first and second scrapers through the respective first and second discharge ports; and
moving the first and second selectively movable discharge gates to the occluding position relative to the respective first and second discharge ports, in response to the controller.

84. A method of sorting as claimed in claim 83, and wherein the step of moving the first and second selectively movable scrapers further comprises:
periodically moving each of the respective scrapers along the length of the respective first and second slots during given time intervals.

85. A method of sorting as claimed in claim 84, and wherein the step of moving the first and second selectively movable scrapers further comprises:
detecting the presence of the at least some of the unacceptable portions that cannot pass through the first and/or second slots;
generating a signal which indicates the presence of the at least some of the unacceptable portions which cannot pass through the first and/or second slots; and
providing the signal to the controller, and wherein the controller, in response to the signal, which is provided, moves the respective first and second scrapers along the respective first and/or second slots, and the first and/or second discharge gates to the nonoccluding position relative to the respective discharge ports.

86. A method of sorting as claimed in claim 85, wherein detecting the presence of the at least some of the unacceptable portions further comprises:
sensing a pressure generated by the moving process stream as it moves through the first and/or second slots, and wherein the at least some of the unacceptable portions which cannot pass through the first and/or second slots increase the relative pressure of the process stream, and wherein the controller causes the first and/or second scrapers to move along the first and/or second slots, and the first and/or second discharge gates to move to the nonoccluding position relative to the first and/or second discharge ports when the sensed pressure reaches a given magnitude.

87. A method of sorting as claimed in claim 81, and wherein the step of transmitting a beam of electromagnetic radiation further comprises:
providing a laser which generates a beam of electromagnetic radiation;
providing a rotating mirror which reflects the beam of electromagnetic radiation and which is generated by the laser; and
directing the beam of electromagnetic radiation, in a first direction, and through the process stream by utilizing the rotating mirror.

88. A method of sorting as claimed in claim 87, and wherein the step of providing a laser further comprises:
providing a laser which generates a beam of electromagnetic radiation having a wavelength between of about 400 to 1000 nm.

89. A method of sorting as claimed in claim 81, and wherein the step of providing a laser further comprises:
providing a laser which generates a beam of electromagnetic radiation having a wavelength of about 532 nm.

90. A method of sorting as claimed in claim 81, and wherein the step of comparing the electrical signal output with the other information further comprises:
providing an electrical processing assembly which receives the electrical signal output which has been converted from the received portion of the electromagnetic radiation, and which has passed through the process stream, and wherein the electrical processing assembly further includes a memory;
providing a plurality of data samples, residing in the memory of the electrical processing assembly, and wherein each data sample is created at a given time, and at predetermined intervals, and wherein each data sample is assigned a value that is approximately equal to the magnitude of the electrical signal output at the given time;
calculating a mathematical average of at least two of the plurality of data samples, and wherein the mathematical average is stored in the memory of the electrical processing assembly; and
utilizing the mathematical average of the at least two of the data samples as information stored in the memory of the electrical processing assembly to facilitate the identification of unacceptable portions in the process stream.

91. A method of sorting, comprising:
providing a process stream having a mixture of acceptable portions having a first hardness, and which pass a predetermined amount of visible light, and unacceptable portions having a second hardness, which is greater than the first hardness, and which further passes an amount of visible light which is less than the amount of visible light which is passed by the acceptable portions;
passing the process stream through an aperture to forcibly deform the process stream and to identify and remove at least some of the unacceptable portions in the process stream which cannot deform and pass through the aperture because of their respective hardness, and wherein substantially all of the acceptable portions of the process stream, and some remaining unacceptable portions pass through the aperture, and form a resulting process stream;
after the step of passing the process stream through the aperture, transmitting a beam of visibly discernible electromagnetic radiation through the resulting process stream to identify any remaining unacceptable portions in the resulting process stream; and
removing the remaining unacceptable portions from the resulting process stream.

92. A method as claimed in claim 92, and wherein the step of passing the process stream through the aperture further comprises:
passing the process stream through two apertures, and wherein the two apertures each have a different size.
